(19) United States
(12) Patent Application Publication
(10) Pub. No.: US 2015/0171418 A1
(43) Pub. Date: Jun. 18, 2015

(54) NEGATIVE ELECTRODE ACTIVE MATERIAL FOR ELECTRICITY STORAGE DEVICE, AND METHOD FOR PRODUCING SAME

(71) Applicants: NATIONAL INSTITUTE OF ADVANCED INDUSTRIAL SCIENCE AND TECHNOLOGY, Tokyo (JP); Nippon Electric Glass Co., Ltd., Shiga (JP)

(72) Inventors: Hideo YAMAUCHI, Shiga (JP); Tomohiro NAGAKANE, Shiga (JP); Akihiko SAKAMOTO, Shiga (JP); Tetsuo SAKAI, Osaka (JP); Meijing ZOU, Osaka (JP)

(21) Appl. No.: 14/633,579

(22) Filed: Feb. 27, 2015

Related U.S. Application Data
(62) Division of application No. 13/502,582, filed on Jul. 16, 2012.

(30) Foreign Application Priority Data
Oct. 22, 2009 (JP) 2009-243155
Oct. 22, 2009 (JP) 2009-243655
Nov. 25, 2009 (JP) 2009-267369
Feb. 12, 2010 (JP) 2010-028357
Apr. 7, 2010 (JP) 2010-088289

(51) Int. Cl. H01M 4/36; H01M 4/48; H01M 4/58

(52) U.S. Cl. CPC H01M 4/364; H01M 4/5825; H01M 4/48; H01M 2004/027

(57) ABSTRACT

A negative electrode active material for an electricity storage device comprises at least SnO as a composition thereof. When a binding energy value of an electron on a Sn 3d_{5/2} orbital of a Sn atom in the negative electrode active material for an electricity storage device is defined as Pl and a binding energy value of an electron on a Sn 3d_{5/2} orbital of a metal Sn is defined as Pm, (Pl−Pm) is 0.01 to 3.5 eV.

### TECHNICAL FIELD

The present invention relates to a negative electrode active material to be used for an electricity storage device such as anon-aqueous secondary battery typified by a lithium ion secondary battery used for portable electronic devices and electric vehicles, and to a method of producing the negative electrode active material.

### BACKGROUND ART

In recent years, owing to widespread use of portable personal computers and portable phones, it has been highly demanded to develop an electricity storage device, such as a lithium ion secondary battery, having a higher capacity and a reduced size. If an electricity storage device has a higher capacity, reduction in size of a battery material can be facilitated, and hence the development of an electrode material for an electricity storage device is urgently needed in order to accomplish the higher capacity.

For example, high potential type materials such as LiCoO₂, LiCo₁₋ₓNiₓO₂, LiNiO₂, and LIMn₂O₄ are each widely used for a positive electrode material for a lithium ion secondary battery, and on the other hand, a carbonaceous material is generally used for a negative electrode material. These materials function as electrode active materials that reversibly store and release lithium ions through charge and discharge, and construct a so-called rocking chair type secondary battery in which both electrodes are electrochemically connected through a non-aqueous electrolytic solution or a solid electrolyte.

Examples of the carbonaceous material used in a negative electrode as an active material (negative electrode active material) that is capable of storing or releasing lithium ions include a graphite carbon material, pitch coke, fibrous carbon, and high-capacity type soft carbon prepared by low-temperature firing. However, each of the carbon materials has a relatively small lithium insertion capacity, and hence involves a problem in that a battery using the carbon material has a low capacity. Specifically, even if a lithium insertion capacity in a stoichiometric amount is attained, the upper limit of the capacity of the battery using the carbon material is about 372 mAh/g.

In view of the foregoing, there is proposed a negative electrode active material containing SnO as a negative electrode active material that is capable of storing and releasing lithium ions and has a higher capacity density than the carbon-based material (see, for example, Patent Literature 1). However, the negative electrode active material proposed in Patent Literature 1 is not capable of abating the change of its volume attributed to the storage and release reactions of Li ions at the time of charge and discharge, and repeated charge and discharge causes remarkable degradation of the structure of the negative electrode active material, and hence a crack is liable to occur. If the crack develops, a void is formed in the negative electrode active material in some cases, and the negative electrode active material may come into fine powder. When a crack occurs in the negative electrode active material, an electron-conducting path is separated in a battery, and hence the negative electrode active material involves a problem of a reduction in discharge capacity after repeated charge and discharge (charge-discharge cycle performance).

Further, there are proposed, in order to solve the above-mentioned problem, a negative electrode active material formed of oxides mainly including tin oxide and a method of producing the negative electrode active material by a melting method (see, for example, Patent Literature 2). In addition, as a method of producing a negative electrode active material which is formed of oxides including tin oxide and silicon oxide, is homogeneous, and has a large specific surface area, there is proposed a production method using a sol-gel method (see, for example, Patent Literature 3). However, the negative electrode active material produced by any of these production methods involves a problem in that a ratio of an initial discharge capacity to an initial charge capacity (initial charge-discharge efficiency) is low and discharge capacity after repeated charge and discharge (cycle performance) is reduced.

In addition, there is proposed a negative electrode active material for a non-aqueous secondary battery, which is excellent in charge-discharge cycle because its volume change attributed to the storage and release of lithium ions can be abated through the use of amorphous oxides mainly including tin oxide (see, for example, Patent Literatures 4 and 5). However, such negative electrode active material contains, in order to produce amorphous oxides, a considerable amount of oxides other than tin oxide, the oxides being not involved in the storage and release of lithium ions. Thus, the negative electrode active material involves a problem in that the content of tin oxide per unit mass thereof is small, and hence it is difficult to attain a higher capacity.

### CITATION LIST

### Patent Literature

Patent Literature 1: JP 2887632 B2
Patent Literature 2: JP 3498380 B2
Patent Literature 3: JP 3890671 B2
Patent Literature 4: JP 3605866 B2
Patent Literature 5: JP 3605875 B2

### SUMMARY OF INVENTION

### Technical Problem

The first object of the present invention is to provide a negative electrode active material that enables a higher capacity of an electricity storage device as compared with conventional negative electrode active materials and is used for producing an electricity storage device which is excellent in charge-discharge cycle performance and safety.

The second object of the present invention is to provide a negative electrode active material that is used for producing an electricity storage device which is excellent in initial charge-discharge efficiency and cycle performance.

The third object of the present invention is to provide a negative electrode active material that is used for producing an electricity storage device which is excellent in cycle performance as compared with those using conventional negative electrode active materials.

### Solution to Problem

The inventors of the present invention have made various studies. As a result, the inventors have found that the first object can be solved by using a negative electrode active material for an electricity storage device, the active material containing tin oxide in its composition at a high ratio, and propose the finding as the present invention. Note that the phrase “electricity storage device” herein includes a non-aqueous secondary battery, in particular, a lithium ion non-aqueous secondary battery used for portable electronic devices such as notebook computers and portable phones, electric vehicles, and the like, and a hybrid capacitor such as a lithium ion capacitor.

That is, the present invention relates to a negative electrode active material for an electricity storage device, comprising, as a composition in terms of mol % on an oxide basis, more than 70 to 95% of SnO and 5 to less than 30% of P₂O₅.

The negative electrode active material for an electricity storage device of the present invention comprises SnO at as high a ratio as more than 70 to 95%, and hence has a large content of tin oxide per unit mass of the negative electrode active material and is capable of providing a higher capacity. Note that the content of the SnO component in the present invention refers to a total content additionally including the contents of tin oxide components (such as SnO₂) other than SnO, provided that the contents of the tin oxide components are calculated in terms of SnO.

In the present invention, the negative electrode active material is preferably substantially amorphous.

According to the above-mentioned constitution, it is possible to abate a volume change attributed to the storage and release of lithium ions, and hence to obtain a negative electrode active material for an electricity storage device that has an excellent charge-discharge cycle. Note that the phrase “be substantially amorphous” refers to having a crystallinity of substantially 0%, that is, in a diffraction line profile in the range of 10 to 600 in terms of a 2θ value obtained by powder X-ray diffraction measurement using Cu Kα-rays, a broad diffraction line is present in the range of 10 to 40° and no diffraction peak is confirmed.

The present invention also relates to a method of producing the above-mentioned negative electrode active material for an electricity storage device, the method comprises the step of melting raw material powder in a reductive atmosphere or an inert atmosphere, thereby causing vitrification thereof.

According to the method, a negative electrode active material than can constitute a secondary battery which is excellent in initial charge-discharge efficiency (the ratio of an initial discharge capacity to an initial charge capacity). The reason for this can be described as follows.

It is known that, in a lithium ion secondary battery, which is one example of anon-aqueous secondary battery, the following reactions take place in its negative electrode at the time of charge and discharge.

Sn^{x+}+xe⁻→Sn (1)

Sn+yLi⁺ye⁻ [symbol] Li_{y}Sn (2)

First, at the time of initial charge, an irreversible reaction in which a Sn^{x+} ion receives an electron, generating metal Sn, takes place (formula (1)). Subsequently, there occurs a reaction in which the generated metal Sn is bound to a Li ion that has transferred from the positive electrode through an electrolytic solution and an electron supplied from a circuit, forming a Sn—Li alloy. The reaction occurs as a reversible reaction in which a reaction proceeds in the right direction at the time of charge and a reaction proceeds in the left direction at the time of discharge (formula (2)).

Here, attention is paid to the reaction of the formula (1) which takes place at the time of initial charge. As the energy which is necessary for causing the reaction is smaller, an initial charge capacity becomes smaller, resulting in excellent initial charge-discharge efficiency. Here, as the valence of a Sn^{x+} ion is smaller (in a reduction state), the number of electrons necessary for reduction becomes smaller, and hence a smaller valence of a Sn^{x+} ion is advantageous for improving the initial charge-discharge efficiency of a secondary battery. In this regard, raw material powder is melted in a reductive atmosphere or an inert atmosphere to cause vitrification thereof, thereby being able to reduce effectively a Sn^{x+} ion to lower the valence thereof, and consequently, a secondary battery excellent in initial charge-discharge efficiency efficiency can be provided.

The raw material powder to be used in the above-mentioned production method preferably contains a complex oxide containing phosphorus and tin.

When the complex oxide containing phosphorus and tin is used as the starting raw material powder, a negative electrode active material excellent in homogeneity can be easily provided. Further, when a negative electrode material containing the negative electrode active material is used as a negative electrode, a non-aqueous secondary battery having a stable discharge capacity is provided.

Further, the inventors of the present invention have made various studies. As a result, the inventors have found that the second object can be solved by adopting a negative electrode active material being used for an electricity storage device such as a non-aqueous secondary battery and containing at least SnO and P₂O₅, and controlling a broad halo pattern derived from an amorphous component (amorphous halo) detected in the range of 10 to 45° in terms of a 2θ value in a diffraction line profile obtained by powder X-ray diffraction (powder XRD) measurement using Cu Kα-rays. Consequently, the finding is proposed as the present invention.

That is, the present invention provides a negative electrode active material for an electricity storage device, comprising at least SnO and P₂O₅, the negative electrode active material having an amorphous halo in the range of 10 to 45° in terms of a 2θ value in a diffraction line profile obtained by powder X-ray diffraction measurement using Cu Kα-rays, wherein, when a curve fitting of the amorphous halo is performed in the range of 10 to 45° in terms of the 2θ by two components, that is, a peak component P1 at the 2θ value which is fixed to 22.5° and a peak component P2 at the 2θ value on a higher angle side than 22.5°, a position of an apex of the peak component P2 is in a range of 25.0 to 29.0° in term of the 2θ value.

The inventors of the present invention have paid attention to the valence of a Sn^{x+} (0<x≦4) ion and the covering state of a phosphate network with respect to Sn^{x+} ions in a negative electrode active material for an electricity storage device, and have found that suitable control of the valence and the covering state provides an electricity storage device which is excellent in initial charge-discharge efficiency and cycle performance. Specifically, the inventors have discovered that, in a diffraction line profile obtained by powder X-ray diffraction measurement, with respect to an amorphous halo in the range of 10 to 45° in terms of a 2θ value, a peak component P1 at the 2θ value which is fixed to 22.5° is attributable to a component of a phosphate network and a peak component P2 at the 2θ value on a higher angle side than 22.5° is attributable to a component derived from tin, and have found that the position of the apex of P2, which is obtained by performing a curve fitting of the amorphous halo with these two components, is controlled to the 2θ value in the range of 25.0 to 29.0°, there can be provided an electricity storage device which is excellent in initial charge-discharge efficiency and cycle performance. A detailed mechanism is described below.

It is known that, in a lithium ion secondary battery, which is one example of anon-aqueous secondary battery, the following reactions take place in its negative electrode at the time of charge and discharge.

Sn^{x+}+xe⁻→Sn (1)

Sn+yLi⁺ye⁻ [symbol] Li_{y}Sn (2)

First, at the time of initial charge, an irreversible reaction in which a Sn^{x+} ion receives an electron, generating metal Sn, takes place (formula (1)). Subsequently, there occurs a reaction in which the generated metal Sn is bound to a Li ion that has transferred from the positive electrode through an electrolytic solution and an electron supplied from a circuit, forming a Sn—Li alloy. The reaction occurs as a reversible reaction in which a reaction proceeds in the right direction at the time of charge and a reaction proceeds in the left direction at the time of discharge (formula (2)).

Here, attention is paid to the reaction of the formula (1) which takes place at the time of initial charge. As the energy which is necessary for causing the reaction is smaller, an initial charge capacity becomes smaller, resulting in excellent initial charge-discharge efficiency. Thus, as the valence of a Sn^{x+} ion is smaller, the number of electrons necessary for reduction becomes small, and hence a smaller valence of a Sn^{x+} ion is advantageous for improving the initial charge-discharge efficiency of a secondary battery.

When powder X-ray diffraction measurement using Cu Kα-rays is performed, the main peak of SnO₂ (cassiterite, tetragonal system, space group P4/nmm), in which the Sn atom is tetravalent, is 26.6° (Miller index (hkl)=(110)) in a crystalline diffraction line. On the other hand, the main peak of SnO (romarchite, tetragonal system, space group P42/mnm), in which the Sn atom is divalent, is detected at 29.9° (Miller index (hkl)=(101)) in a crystalline diffraction line. Thus, when a Sn atom has a lower valence, a main peak is detected on a higher angle side.

Sn^{x+} ions in the negative electrode active material of the present invention are not crystals (ordered structure) such as SnO and SnO₂ but amorphous oxides (disordered structure), and exist in a state in which the valences x of the Sn^{x+} ions are continuously changing. Thus, a diffraction line profile obtained by powder X-ray diffraction measurement exhibits a broad scatter band, and the 2θ value of the apex of the peak component P2 detected on a higher angle side than 22.5° reflects the average valence of the Sn^{x+} ions. Thus, the position of the apex of the P2 is controlled in the range described above, thereby being able to provide a secondary battery excellent in initial charge-discharge efficiency.

By the way, when a Sn^{x+} ion is formed into a Li_{y}Sn alloy at the time of initial charge, a negative electrode active material stores y pieces of lithium ions released from a positive electrode material, resulting in the expansion of its volume. This volume change can be calculated in terms of crystallography. For example, a SnO crystal has a tetragonal system whose crystal unit cell has lengths of 3.802 \acute{Å} by 3.802 \acute{Å} by 4.836 \acute{Å}, and hence its crystal unit volume comes to 69.9 \acute{Å}³. The crystal unit cell includes two Sn atoms, and hence the occupied volume of one Sn atom comes to 34.95 \acute{Å}³. On the other hand, there are known, as the Li_{y}Sn alloy formed at the time of charge, alloys of Li_{2.6}Sn, Li₃. Sn, Li_{4.4}Sn, and the like. When a case where a Li_{4.4}Sn alloy is formed at the time of charge is taken as an example, the unit cell of Li_{4.4}Sn (cubic system, space group F23) has lengths of 19.78 \acute{Å} by 19.78 \acute{Å} by 19.78 \acute{Å}, and hence its cell unit volume comes to 7739 \acute{Å}³. The unit cell includes 80 Sn atoms, and hence the occupied volume of one Sn atom comes to 96.7 \acute{Å}³. Thus, if a SnO crystal is used for a negative electrode material, the occupied volume of the Sn atom expands 2.77-fold (96.7 \acute{Å}³/34.95 \acute{Å}³) at the time of initial charge.

Next, at the time of discharge, the reaction in the formula (2) proceeds in the left direction and y pieces of Li ions and y pieces of electrons are released from the Li_{y}Sn alloy, forming metal Sn, and hence the volume of the negative electrode active material contracts. In this case, the contraction rate of the volume is calculated in terms of crystallography as described previously. Metal Sn has a tetragonal system whose unit cell has lengths of 5.831 \acute{Å} by 5.831 \acute{Å} by 3.182 \acute{Å}, and hence its unit cell volume comes to 108.2 \acute{Å}³. The unit cell includes four Sn atoms, and hence the occupied volume of one Sn atom comes to 27.05 \acute{Å}³. Thus, when the Li_{y}Sn alloy is a Li_{4.4}Sn alloy, the discharge reaction proceeds in the negative electrode active material, producing metal Sn, and consequently, the occupied volume of the Sn atom contracts 0.28-fold (27.5 \acute{Å}³/96.7 \acute{Å}³)

Further, at the time of a second charge onward, the reaction in the formula (2) proceeds in the right direction and metal Sn stores y pieces of Li ions and y pieces of electrons, generating a Li_{y}Sn alloy, and hence the volume of the negative electrode active material expands. In this case, when the metal Sn is formed into Li_{4.4}Sn, the occupied volume of the Sn atom expands 3.52-fold (96.7 \acute{Å}³/27.5 \acute{Å}³).

As described above, a negative electrode active material containing SnO undergoes a remarkable volume change at the time of charge and discharge, and hence repeated charge and discharge is liable to generate a crack in the negative electrode active material. If the crack develops, a void is formed in the negative electrode active material in some cases, and the negative electrode active material may come into fine powder. When a crack occur in the negative electrode active material, an electron-conducting network is divided in a battery, and the charge-discharge capacity of the battery is liable to lower, causing the reduction of a cycle performance.

Sn^{x+} ions are present in the negative electrode active material of the present invention in the state of being covered by a phosphate network, and hence the phosphate network can contribute to abating the change of the volume of each Sn atom attributed to charge and discharge. Here, the valence of each of the Sn^{x+} ions is influenced by the coordination of lone pairs of electrons owned by each oxygen atom in the phosphate network, and hence the 2θ value of the apex of the peak component P2 probably reflects not only the average valence of the Sn^{x+} ions but also the covering state of the phosphate network with respect to the Sn^{x+} ions. In the negative electrode active material of the present invention, the position of the apex of the P2 is regulated in the range described above, and hence it is possible to control the covering state of the phosphate network with respect to the Sn^{x+} ions and to abate effectively the change of the volume of each Sn atom attributed to charge and discharge. As a result, a secondary battery excellent in cycle performance at the time of repeated charge and discharge can be provided.

The present invention also provides a negative electrode active material for an electricity storage device, comprising at least SnO and P₂O₅, the negative electrode active material having an amorphous halo in a range of 10 to 45° in terms of a 2θ value in a diffraction line profile obtained by powder X-ray diffraction measurement using Cu Kα-rays, wherein, when a curve fitting of the amorphous halo is performed in the range of 10 to 45° in terms of the 2θ by two components, that is, a peak component P1 at the 2θ value which is fixed to 22.5° and a peak component P2 at the 2θ value on a higher angle side than 22.5°, a peak area A1 of the peak component P1 and a peak area A2 of the peak component P2 satisfy a relationship of A1/A2=0.01 to 8.

As already described, the peak component P1 is attributable to a component of a phosphate network and the peak component P2 is attributable to a component derived from tin. Thus, through the regulation of a ratio of the peak areas A1/A2 in regard to these peak components in the above-mentioned range, it is possible to control the covering state of the phosphate network with respect to Sn^{x+} ions and to abate effectively the change of the volume of each Sn atom attributed to charge and discharge. As a result, there can be provided an electricity storage device such as a secondary battery excellent in cycle performance at the time of repeated charge and discharge.

The negative electrode active material of the present invention preferably comprises, as a composition in terms of mol %, 45 to 95% of SnO and 5 to 55% of P₂O₅.

Further, the negative electrode active material of the present invention is preferably substantially amorphous.

According to such constitution, there is provided a negative electrode active material that is capable of abating a volume change attributed to the storage and release of lithium ions, and hence it is possible to provide an electricity storage device such as a secondary battery which has an excellent charge-discharge cycle performance. Note that the phrase “be substantially amorphous” means that no crystalline diffraction line is detected in powder X-ray diffraction measurement using Cu Kα-rays, that is, refers to having a crystallinity of substantially 0%, and specifically, a crystallinity of 0.1% or less.

The present invention also provides a method of producing the above-mentioned negative electrode active material for an electricity storage device, the method comprises the step of melting raw material powder in a reductive atmosphere or an inert atmosphere, thereby causing vitrification thereof.

According to the method, the valence of a Sn ion in a negative electrode material can be reduced, and hence an electricity storage device excellent in initial charge-discharge efficiency can be provided because of the reasons described previously.

The raw material powder to be used in the above-mentioned production method preferably contains a complex oxide containing phosphorus and tin.

When the complex oxide containing phosphorus and tin is used as the starting raw material powder, a negative electrode active material excellent in homogeneity can be easily provided. Further, when a negative electrode material containing the negative electrode active material is used as a negative electrode, an electricity storage device having a stable discharge capacity is provided.

Further, the inventors of the present invention have made various studies. As a result, the inventors have found that the third object can be solved by adopting, as a negative electrode active material to be used for an electricity storage device such as a non-aqueous secondary battery, a negative electrode active material which has a specific diffraction line profile when powder X-ray diffraction measurement using Cu Kα-rays is performed. Consequently, the finding is proposed as the present invention.

That is, the present invention provides a negative electrode active material to be used for an electricity storage device comprising at least a negative electrode and a positive electrode, wherein the negative electrode active material exhibits a full width at half maximum of a diffraction line peak of 0.5° or more at a time of completion of charge, the diffraction line peak being detected in a range of 30 to 500 in terms of a 2θ value and/or in a range of 10 to 30° in terms of a 2θ value in a diffraction line profile obtained by powder X-ray diffraction measurement using Cu Kα-rays.

Note that the phrase “at a time of completion of charge” in the present invention refers to in a state in which a test battery is charged to 0 V at a constant current of 0.2 mA, the test battery being provided by using a negative electrode material containing the negative electrode active material for an electricity storage device of the present invention as its negative electrode, using metal lithium as its positive electrode, and using a 1 M LiPF₆ solution/EC:DEC=1:1 (EC=ethylene carbonate, DEC=diethyl carbonate) as its electrolytic solution.

The present invention also provides a negative electrode active material to be used for an electricity storage device comprising at least a negative electrode and a positive electrode, wherein the negative electrode active material exhibits a full width at half maximum of a diffraction line peak of 0.10 or more at a time of completion of discharge, the diffraction line peak being detected in a range of 15 to 40° in terms of a 2θ value in a diffraction line profile obtained by powder X-ray diffraction measurement using Cu Kα-rays.

Note that the phrase “at a time of completion of discharge” in the present invention refers to in a state in which a test battery is discharged to 1 V at a constant current of 0.2 mA, the test battery being provided by using a negative electrode material containing the negative electrode active material for an electricity storage device of the present invention as its negative electrode, using metal lithium as its positive electrode, and using a 1 M LiPF₆ solution/EC:DEC=1:1 as its electrolytic solution.

It is known that, in a lithium ion secondary battery, which is one example of anon-aqueous secondary battery, the following reaction takes place in its negative electrode containing Sn at the time of charge and discharge.

Sn+yLi⁺ye⁻ [symbol] LiySn (1)

First, at the time of charge, there occurs a reaction in which metal Sn is bound to a Li ion that has transferred from the positive electrode through the electrolytic solution and an electron supplied from a circuit, forming a Sn—Li (Li_{y}Sn) alloy (formula (1)).

When the Sn metal is formed into the Li_{y}Sn alloy at the time of the charge, a negative electrode active material stores y pieces of Li ions released from the positive electrode, resulting in the expansion of its volume. This volume change can be estimated in terms of crystallography.

For example, metal Sn has a tetragonal system whose unit cell has lengths of 5.831 \acute{Å} by 5.831 \acute{Å} by 3.182 \acute{Å}, and hence its unit cell volume comes to 108.2 \acute{Å}³. The unit cell includes four Sn atoms, and hence the occupied volume of one Sn atom comes to 27.05 \acute{Å}³. On the other hand, there are known, as the Li_{y}Sn alloy formed at the time of charge, alloys of Li_{2.6}Sn, Li_{3.5}Sn, Li_{4.4}Sn, and the like. When a case that a Li_{4.4}Sn alloy is formed at the time of charge is taken as an example, the unit cell of Li_{4.4}Sn (cubic system, space group F23) has lengths of 19.78 \acute{Å} by 19.78 \acute{Å} by 19.78 \acute{Å}, and hence its cell unit volume comes to 7739 \acute{Å}³. The unit cell includes 80 Sn atoms, and hence the occupied volume of one Sn atom comes to 96.7 \acute{Å}³. Thus, the occupied volume of the Sn atom expands 3.52-fold (96.7 \acute{Å}³/27.05 \acute{Å}³) at the time of charge.

Next, at the time of discharge, the reaction in the formula (1) proceeds in the left direction and y pieces of Li ions and y pieces of electrons are released from the Li_{y}Sn alloy, forming metal Sn, and hence the volume of the negative electrode active material contracts. In this case, the occupied volume of the Sn atom contracts 0.28-fold (27.5 \acute{Å}³/96.7 \acute{Å}³)

As described above, a negative electrode active material containing metal Sn undergoes a remarkable volume change at the time of charge and discharge, and hence, as described previously, repeated charge and discharge is liable to produce a crack in the negative electrode active material, consequently causing the reduction of a cycle performance.

By the way, in a negative electrode active material for a non-aqueous secondary battery, Sn—Li alloy fine particles are formed at the time of completion of charge, and metal Sn fine particles are formed at the time of completion of discharge because Li ions are released. In this regard, the inventors of the present invention have found that, when a negative electrode active material has a structure in which Sn—Li alloy fine particles and Sn fine particles serving as the storage or release sites of Li ions are uniformly dispersed at a nanosize level (about 0.1 to 10 nm), the change of the volume of the active material attributed to charge and discharge reactions can be abated, consequently providing a secondary battery having an excellent cycle performance. Then, the inventors have paid attention to a diffraction line profile obtained by powder X-ray diffraction measurement using Cu Kα-rays, and have clarified that, if a negative electrode active material has a specific diffraction line profile, the crystallite size of a Sn—Li alloy fine particle and that of a Sn fine particle are nanosize, and these fine particles are in the state of uniformly existing in a matrix such as a network-forming oxide.

Specifically, in a negative electrode active material at the time of completion of charge, a diffraction line peak detected in the range of 30 to 50° in terms of the 2θ value or the range of 10 to 30° in terms of the 2θ value in a diffraction line profile obtained by powder X-ray diffraction measurement using Cu Kα-rays is attributable to the metal crystal phase of Li_{y}Sn (y=0.3 to 4.4), and if the full width at half maximum of the diffraction line peak is 0.5° or more, it is shown that the crystallite size of the metal crystal is nanosize. Further, in a negative electrode active material at the time of completion of discharge, a diffraction line peak detected in the range of 15 to 40° in terms of the 2θ value in a diffraction line profile obtained by powder X-ray diffraction measurement using Cu Kα-rays is attributable to the metal crystal phase of metal Sn, and it has been clarified that, if the full width at half maximum of the diffraction line peak is 0.1° or more, the crystallite of the metal crystal is shown to be a nanosize fine particle. In addition, through the regulation of each full width at half maximum in each of the above-mentioned ranges, the change of the volume of each Sn atom attributed to charge and discharge can be absorbed and abated, and as a result, there can be provided a secondary battery which is excellent in cycle performance at the time of repeated charge and discharge.

The negative electrode active material for an electricity storage device of the present invention preferably comprises, as a composition in terms of mol % on an oxide basis, 10 to 70% of SnO, 20 to 70% of Li₂O, and 2 to 40% of P₂O₅ at a time of completion of discharge.

Note that the content of SnO herein refers to a total content additionally including the contents of Sn components other than SnO (such as SnO₂ and metal Sn), provided that the contents of the Sn components other than SnO are calculated in terms of SnO.

Further, the inventors of the present invention have made various studies. As a result, the inventors have found that the second object can be solved by controlling the electron binding energy of Sn atoms in a negative electrode active material for an electricity storage device containing tin oxide. Thus, the finding is proposed as the present invention.

That is, the present invention provides a negative electrode active material for an electricity storage device, comprising at least SnO as a composition thereof, wherein, when a binding energy value of an electron on a Sn 3d_{5/2} orbital of a Sn atom in the negative electrode active material for an electricity storage device is defined as Pl and a binding energy value of an electron on a Sn 3d_{5/2} orbital of metal Sn is defined as Pm, (Pl−Pm) is 0.01 to 3.5 eV.

It is known that, in a lithium ion secondary battery, which is one example of a non-aqueous secondary battery as an electricity storage device, the following reactions take place in its negative electrode at the time of charge and discharge.

Sn^{x+}+xe⁻→Sn (1)

Sn+yLi⁺ye⁻ [symbol] Li_{y}Sn (2)

First, at the time of initial charge, an irreversible reaction in which a Sn^{x+} ion receives an electron, producing metal Sn, takes place (formula (1)). Subsequently, there occurs a reaction in which the produced metal Sn is bound to a Li ion that has transferred from the positive electrode through an electrolytic solution and an electron supplied from a circuit, forming a Sn—Li alloy. The reaction occurs as a reversible reaction in which a reaction proceeds in the right direction at the time of charge and a reaction proceeds in the left direction at the time of discharge (formula (2)).

Here, attention is paid to the reaction of the formula (1) which takes place at the time of initial charge. As the energy which is necessary for causing the reaction is smaller, an initial charge capacity becomes smaller, resulting in excellent initial charge-discharge efficiency. Thus, as the valence of a Sn^{x+} ion is smaller, the number of electrons necessary for reduction becomes smaller, and hence a smaller valence of a Sn^{x+} ion is advantageous for improving the initial charge-discharge efficiency of a secondary battery.

The inventors of the present invention have introduced the binding energy value Pl of an electron on the Sn 3d_{5/2} orbital of a Sn atom as an index showing the state of the valence of a Sn^{x+} ion in a negative electrode. In addition, the inventors have found that, through the regulation of the difference (Pl−Pm) between the binding energy value Pl and the binding energy value Pm of an electron on the Sn 3d_{5/2} orbital of metal Sn to 3.5 eV or less, there is provided an electricity storage device excellent in initial charge-discharge efficiency.

On the other hand, a negative electrode active material having an excessively small value for (Pl−Pm) has a structure similar to that of metal Sn, and the volume of the negative electrode active material remarkably changes owing to the storage and release of lithium ions. Thus, repeated charge and discharge tends to cause a significant reduction in discharge capacity. In this regard, the inventors have found that regulating (Pl−Pm) to 0.01 eV or more abates the volume change caused by the storage and release of lithium ions at the time of repeated charge and discharge, thereby providing an electricity storage device excellent in cycle performance.

Note that in the present invention, the binding energy value of an electron on the Sn 3d_{5/2} orbital of a Sn atom refers to a binding energy value at a point at which the maximum detection intensity is obtained in a X-ray photoelectron spectroscopy spectrum of the Sn 3d_{5/2} orbital using Mg Kα-rays.

The negative electrode active material for an electricity storage device of the present invention is preferably substantially amorphous.

According to the above-mentioned constitution, there is provided a negative electrode active material that is capable of abating a volume change attributed to the storage and release of lithium ions, and hence it is possible to provide an electricity storage device which has an excellent charge-discharge cycle performance. Note that, in the present invention, the phrase “be substantially amorphous” refers to having a crystallinity of substantially 0%, and specifically, refers to the fact that no crystalline diffraction line is detected in powder X-ray diffraction measurement using Cu Kα-rays.

The negative electrode active material for an electricity storage device of the present invention is preferably in a state of powder.

When the negative electrode active material for an electricity storage device is in a state of powder, its specific surface area is larger and its capacity can be enhanced.

The negative electrode active material for an electricity storage device of the present invention preferably has an average particle diameter of 0.1 to 10 μm and a maximum particle diameter of 75 μm or less.

The present invention also provides a method of producing the negative electrode active material for an electricity storage device as mentioned-above, the method comprising the step of melting raw material powder in a reductive atmosphere or an inert atmosphere, thereby causing vitrification thereof.

According to the method, the valence of a Sn ion in a negative electrode active material can be reduced, and hence an electricity storage device excellent in initial charge-discharge efficiency can be provided because of the reasons described previously.

The raw material powder to be used in the production method of the present invention preferably comprises metal powder or carbon powder.

According to the method, a Sn component in a negative electrode active material can be reduced to decrease the valence of a Sn ion. Thus, because of the reasons described previously, an electricity storage device excellent in initial charge-discharge efficiency can be provided.

The raw material powder to be used in the production method of the present invention preferably includes a complex oxide containing phosphorus and tin.

When the complex oxide containing phosphorus and tin is used as the starting raw material powder, a negative electrode material excellent in homogeneity can be easily provided. When the negative electrode material containing the negative electrode active material is used as a negative electrode, an electricity storage device having a stable discharge capacity is provided.

### BRIEF DESCRIPTION OF DRAWINGS

FIG. 1 is a diagram showing a powder X-ray diffraction line profile of the negative electrode material of Example 4 in Table 2.

FIG. 2 is a diagram showing a base line at a time of performing background subtraction by a straight-line fit with respect to the powder X-ray diffraction line profile of the negative electrode material of Example 4 in Table 2.

FIG. 3 is a diagram showing results of curve fittings with respect to peak components P1 and P2 in a diffraction line profile of the negative electrode material of Example 4 in Table 2, the diffraction line profile being prepared by performing background subtraction.

FIG. 4 is a diagram showing a profile obtained by performing background subtraction from a diffraction line profile of the negative electrode active material of Example 2 in Table 5, the diffraction line profile being prepared at a time of charge to 0 V.

FIG. 5 is a diagram showing a profile obtained by performing background subtraction from a diffraction line profile of the negative electrode active material of Example 2 in Table 5, the diffraction line profile being prepared at a time of discharge to 1 V.

FIG. 6 is a diagram showing a XPS spectrum of the 3d_{5/2} orbital of a Sn atom in the negative electrode material of Example 5 in Table 7 and a XPS spectrum of the 3d_{5/2} orbital of metal Sn.

### DESCRIPTION OF EMBODIMENTS

A negative electrode active material for an electricity storage device according to Embodiment 1 of the present invention comprises, as a composition including in terms of mol %, more than 70 to 95% of SnO and 5 to less than 30% of P₂O₅. The reasons for restricting the composition as mentioned above are described below. Note that the term “%” refers to “mol %” in the following descriptions unless otherwise specified.

SnO is an active material component serving as a site for storing and releasing lithium ions in the negative electrode active material. The content of SnO is preferably more than 70 to 95%, 70.1 to 87%, or 70.5 to 82%, particularly preferably 71 to 77%. When the content of SnO is 70% or less, the discharge capacity per unit mass of the resultant negative electrode active material becomes smaller, and charge-discharge efficiency at the time of initial charge and discharge becomes smaller. When the content of SnO is more than 95%, the amount of amorphous components in the resultant negative electrode active material becomes smaller, it is not possible to abate sufficiently a volume change attributed to the storage and release of lithium ions at the time of charge and discharge, and consequently, a sharp reduction in capacity may occur at the time of repeated charge and discharge.

P₂O₅ is a matrix component covering SnO serving as a site for storing and releasing lithium ions, and has the function of abating a volume change which occurs when SnO stores and releases lithium ions, thereby improving the charge-discharge cycle performance of a negative electrode active material. Besides, P₂O₅ is a network-forming oxide and functions as a solid electrolyte in which lithium ions are movable. The content of P₂O₅ is preferably 5 to less than 30% or 5 to 29.2%, particularly preferably 8 to 29.5%. When the content of P₂O₅ is less than 5% in a negative electrode active material, it is not possible to abate a volume change attributed to the storage and release of lithium ions at the time of charge and discharge, and hence its structural degradation is liable to be caused. Thus, the cycle performance of a negative electrode active material is very bad, probably leading to a rapid reduction in its capacity. When the content of P₂O₅ is 30% or more, the discharge capacity per unit mass of the resultant negative electrode active material tends to lower, and moreover, its water resistance is liable to deteriorate, and consequently, undesirable other crystals (such as SnHPO₄) may be generated after exposure to high temperature and high humidity for a long period, or the negative electrode active material is liable to be impregnated with or adsorb moisture. As a result, in a non-aqueous secondary battery using the negative electrode active material, water splits, releasing oxygen and resulting in its explosion, or heat is produced through a reaction between lithium and water, causing ignition, and hence the negative electrode active material has inferior safety.

Note that the total content of SnO and P₂O₅ is preferably 80% or more or 85% or more, particularly preferably 87% or more. When the total content of SnO and P₂O₅ is less than 80%, compatibility between a cycle performance and a high capacity may become difficult to achieve.

The molar ratio of SnO to P₂O₅ (SnO/P₂O₅) is preferably 2.3 to 19 or 2.3 to 18, particularly preferably 2.4 to 17. When the SnO/P₂O₅ is less than 2.3, the Sn atom in SnO is liable to be influenced by the coordination of P₂O₅ and the valence of the Sn atom tends to increase, with the result that the initial charge-discharge efficiency tends to reduce. When the SnO/P₂O₅ is more than 19, the discharge capacity tends to reduce largely at the time of repeated charge and discharge. This is probably because the number of P₂O₅ coordinating to SnO decreases in the resultant negative electrode active material, the P₂O₅ component cannot cover SnO, and consequently, it is not possible to abate the change of the volume of SnO attributed to the storage and release of lithium ions, causing its structural degradation.

Besides, as long as the effects of the present invention are not impaired, various components can be further added in addition to the above-mentioned components. Examples of such components include CuO, ZnO, B₂O₃, MgO, CaO, Al₂O₃, SiO₂, and R₂O (R represents Li, Na, K, or Cs). The total content of the above-mentioned components is preferably 0 to 20% or 0 to 15%, particularly preferably 0.1 to 13%.

The negative electrode active material for an electricity storage device according to Embodiment 1 has a crystallinity of preferably 95% or less, 80% or less, 70% or less, or 50% or less, particularly preferably 30% or less, and is most preferably substantially amorphous (has a crystallinity of substantially 0%). As a negative electrode active material containing SnO at a high ratio has a smaller crystallinity (has a larger ratio of an amorphous phase), the change of its volume at the time of repeated charge and discharge can be more abated, and hence having a smaller crystallinity is advantageous from the viewpoint of suppressing the reduction of a discharge capacity.

The crystallinity of a negative electrode active material is determined by performing peak separation to each crystalline diffraction line and an amorphous halo in a diffraction line profile ranging from 10 to 60° in terms of the 2θ value obtained by powder X-ray diffraction measurement using Cu Kα-rays. Specifically, when an integral intensity obtained by performing the peak separation of a broad diffraction line (amorphous halo) in the range of 10 to 40° from a total scattering curve obtained by performing background subtraction from the diffraction line profile is defined as Ia, and the total sum of integral intensities obtained by performing the peak separation of each crystalline diffraction line detected in the range of 10 to 60° from the total scattering curve is defined as Ic, the crystallinity Xc can be calculated on the basis of the following equation.

Xc=[Ic/(Ic+Ia)]×100

The negative electrode active material according to Embodiment 1 may contain a phase formed of a complex oxide of a metal and an oxide or an alloy phase of a metal and another metal.

Note that, after an electricity storage device such as a non-aqueous secondary battery using a negative electrode material containing the negative electrode active material according to Embodiment 1 is charged and discharged, the negative electrode material contains lithium oxides, a Sn—Li alloy, or metal tin in some cases.

The negative electrode active material according to Embodiment 1 is produced by, for example, melting raw material powder under heating, thereby causing the vitrification thereof. Here, the melting of the raw material powder is preferably carried out in a reductive atmosphere or an inert atmosphere.

In an oxide containing Sn, the oxidation state of a Sn atom easily changes depending on melting conditions, and hence the binding energy of an electron easily changes. If melting is carried out in a reductive atmosphere or an inert atmosphere, the change of the oxidation state of a Sn atom can be suppressed as mentioned previously, and thus a secondary battery excellent in initial charge-discharge efficiency can be provided.

In order to carry out melting in a reductive atmosphere, it is preferred to supply a reductive gas into a melting tank. It is preferred to use, as the reductive gas, a mixed gas including, in terms of vol %, 90 to 99.5% of N₂ and 0.5 to 10% of H₂, and it is particularly preferred to use a mixed gas including 92 to 99% of N₂ and 1 to 8% of H₂.

When melting is carried out in an inert atmosphere, it is preferred to supply an inert gas into a melting tank. It is preferred to use, as the inert gas, any of nitrogen, argon, and helium.

Further, in the method of producing the negative electrode active material according to Embodiment 1, it is preferred to use a complex oxide containing phosphorus and tin as starting raw material powder. When the complex oxide containing phosphorus and tin is used as the starting raw material powder, it is easier to produce a negative electrode active material which contains devitrified material at a small ratio and is excellent inhomogeneity. The use of a negative electrode material containing the negative electrode active material as a negative electrode allows the provision of a non-aqueous secondary battery having a stable discharge capacity. Examples of the complex oxide containing phosphorus and tin include stannous pyrophosphate (Sn₂P2O₇).

A negative electrode active material for an electricity storage device according to Embodiment 2 of the present invention comprises at least SnO and P₂O₅ and has an amorphous halo in the range of 10 to 45° in terms of a 2θ value in a diffraction line profile obtained by powder X-ray diffraction measurement using Cu Kα-rays, wherein, when a curve fitting of the amorphous halo is performed in the range of 10 to 45° in terms of the 2θ by two components, that is, a peak component P1 at the 2θ value which is fixed to 22.5° and a peak component P2 at the 2θ value on a higher angle side than 22.5°, a position of an apex of the peak component P2 is in a range of 25.0 to 29.0° in term of the 2θ value.

When the position of the peak component P2 corresponds to the 2θ value less than 25.0°, each of Sn ions in the resultant negative electrode active material is present in the state of being strongly influenced by the coordination of lone pairs of electrons of each oxygen atom existing in a phosphate network. As a result, at the time of initial charge, it is required to use an excessive amount of electrons necessary for reducing Sn atoms in the negative electrode active material to metal Sn and an excessive amount of lithium ions necessary for charge compensation, and hence the initial charge-discharge efficiency remarkably lowers. On the other hand, when the peak position of the peak component P2 corresponds to the 2θ value more than 29.0°, tin oxide in the resultant negative electrode active material is not sufficiently covered by a phosphate network, which means that tin oxide is present mainly as a SnO molecular group. Thus, at the time of repeated charge and discharge, the change of the volume of the negative electrode active material locally occurs, and the skeleton of the phosphate network is broken, causing its structural failure. As a result, the discharge capacity tends to lower at the time of repeated charge and discharge. The peak position of the peak component P2 is in the range of preferably 25.1 to 28.8°, 25.3 to 28.5°, or 25.5 to 28.3°, more preferably 25.7 to 28.0°. Note that the peak position of the peak component P2 can be regulated in the range by appropriately adjusting a ratio between SnO and P₂O₅ in a negative electrode active material and a melting atmosphere.

Further, in another mode, the negative electrode active material for an electricity storage device according to Embodiment 2 of the present invention comprises at least SnO and P₂O₅ and has an amorphous halo in the range of 10 to 45° in terms of a 2θ value in a diffraction line profile obtained by powder X-ray diffraction measurement using Cu Kα-rays, wherein, when a curve fitting of the amorphous halo is performed in the range of 10 to 45° in terms of the 20 by two components, that is, a peak component P1 at the 20 value which is fixed to 22.5° and a peak component P2 at the 20 value on a higher angle side than 22.5°, a peak area A1 of the peak component P1 and a peak area A2 of the peak component P2 satisfy a relationship of A1/A2=0.01 to 8.

When the peak area ratio A1/A2 is less than 0.01, only a small number of chained phosphates are present in the resultant negative electrode active material, the chain of each chained phosphate is cut, and phosphates are present as isolated phosphates, which means that tin oxide is not sufficiently covered by a phosphate network. Thus, phosphate skeletons are liable to be broken owing to the change of the volume of the negative electrode active material attributed to repeated charge and discharge, probably causing its structural failure. As a result, the discharge capacity tends to lower at the time of repeated charge and discharge. On the other hand, when the peak area ratio A1/A2 is more than 8, each of Sn ions in the resultant negative electrode active material is present in the state of being strongly influenced by the coordination of lone pairs of electrons owned by each oxygen atom existing in a phosphate network. Thus, at the time of initial charge, it is required to use an excessive amount of electrons necessary for reducing Sn atoms in the negative electrode active material to metal Sn and an excessive amount of lithium ions necessary for charge compensation, and hence the initial charge-discharge efficiency remarkably lowers. The peak area ratio A1/A2 is in the range of preferably 0.02 to 7.5, 0.1 to 6.5, or 0.2 to 5.5, more preferably 0.3 to 4.5.

Note that the peak area ratio A1/A2 can be regulated in the range by appropriately adjusting a ratio between SnO and P₂O₅ in a negative electrode active material and a melting atmosphere.

As described above, the negative electrode active material for an electricity storage device according to Embodiment 2 comprises at least SnO and P₂O₅ as its composition.

SnO is an active material component serving as a site for storing and releasing lithium ions in a negative electrode material. The content of SnO is, in terms of mol %, preferably 45 to 95% or 50 to 90%, particularly preferably 55 to 85%. When the content of SnO is less than 45%, the capacity per unit mass of the resultant negative electrode active material becomes smaller. When the content of SnO is more than 95%, the amount of amorphous components in the resultant negative electrode active material becomes smaller, and hence it is not possible to abate a volume change attributed to the storage and release of lithium ions at the time of charge and discharge, possibly resulting in a sharp reduction in discharge capacity. Note that the content of the SnO component in the present invention refers to a total content additionally including the contents of tin oxide components other than SnO (such as SnO₂), provided that the contents of the tin oxide components are calculated in terms of SnO.

P₂O₅ is a network-forming oxide, covers a site of SnO for storing and releasing lithium ions, and functions as a solid electrolyte in which lithium ions are movable. The content of P₂O₅ is, in terms of mol %, preferably 5 to 55% or 10 to 50%, particularly preferably 15 to 45%. When the content of P₂O₅ is less than 5% in a negative electrode active material, it is not possible to abate the change of the volume of SnO attributed to the storage and release of lithium ions at the time of charge and discharge, resulting in its structural degradation, and hence the discharge capacity is liable to reduce significantly at the time of repeated charge and discharge. When the content of P₂O₅ is more than 55%, a stable crystal (such as SnP₂O₇) is easily formed together with a Sn atom, bringing about such a state that the influence of coordinate bonds to a Sn atom by lone pairs of electrons owned by each oxygen atom in chained P₂O₅ is more intensified. As a result, the peak position of the peak component P2 shifts to a lower angle side, and hence the initial charge-discharge efficiency tends to lower.

The molar ratio of SnO to P₂O₅ (SnO/P₂O₅) is preferably 0.8 to 19 or 1 to 18, particularly preferably 1.2 to 17. When the SnO/P₂O₅ is less than 0.8, the Sn atom in SnO is liable to be influenced by the coordination of P₂O₅ and the peak position of the peak component P2 shifts to a lower angle side, with the result that the initial charge-discharge efficiency tends to reduce. On the other hand, when the SnO/P₂O₅ is more than 19, the discharge capacity is liable to lower at the time of repeated charge and discharge. This is probably because the number of P₂O₅ coordinating to SnO decreases in the resultant negative electrode active material, P₂O₅ cannot cover SnO sufficiently, and consequently, it is not possible to abate the change of the volume of SnO attributed to the storage and release of lithium ions, causing its structural degradation.

Besides, various components can be further added to the negative electrode active material according to Embodiment 2, in addition to the above-mentioned components. For example, CuO, ZnO, B₂O₃, MgO, CaO, Al₂O₃, SiO₂, and R₂O (R represents Li, Na, K, or Cs) can be contained at a total content of preferably 0 to 20% or 0 to 10%, particularly preferably 0 to 7%. When the total content is more than 20%, vitrification easily occurs, but a phosphate network is liable to be cut. As a result, the discharge capacity tends to lower at the time of repeated charge and discharge. Further, A1 decreases and a peak area ratio A1/A2 becomes smaller, resulting in the degradation of the cycle performance.

The negative electrode active material according to Embodiment 2 is formed of an amorphous substance and/or a crystalline substance containing, for example, a plurality of oxide components in its composition. The negative electrode active material has a crystallinity of preferably 95% or less, 80% or less, 70% or less, or 50% or less, particularly preferably 30% or less, and is most preferably substantially amorphous. As a negative electrode active material containing SnO at a high ratio has a smaller crystallinity (has a larger ratio of an amorphous phase), the change of its volume at the time of repeated charge and discharge can be more abated, and hence having a smaller crystallinity is advantageous from the viewpoint of suppressing the reduction of a discharge capacity.

The crystallinity of a negative electrode active material is determined by performing peak separation to each crystalline diffraction line and an amorphous halo in a diffraction line profile ranging from 10 to 60° in terms of a 2θ value obtained by powder X-ray diffraction measurement using Cu Kα-rays. Specifically, when an integral intensity obtained by carrying out the peak separation of a broad diffraction line (amorphous halo) in the range of 10 to 45° from a total scattering curve obtained by performing background subtraction from the diffraction line profile is defined as Ia, and the total sum of integral intensities obtained by carrying out the peak separation of each crystalline diffraction line detected in the range of 10 to 60° from the total scattering curve is defined as Ic, the crystallinity Xc can be calculated on the basis of the following equation.

Xc=[Ic/(Ic+Ia)]×100(%)

The negative electrode active material according to Embodiment 2 may contain a phase formed of a complex oxide of a metal and an oxide or an alloy phase of a metal and another metal.

Note that, after an electricity storage device such as a non-aqueous secondary battery using a negative electrode material containing the negative electrode active material according to Embodiment 2 is charged and discharged, the negative electrode material contains lithium oxides, a Sn—Li alloy, or metal tin in some cases.

The negative electrode active material according to Embodiment 2 is produced by, for example, melting raw material powder under heating, thereby causing the vitrification thereof. Here, the melting of the raw material powder is preferably carried out in a reductive atmosphere or an inert atmosphere.

In an oxide containing Sn, the oxidation state of a Sn atom easily changes depending on melting conditions, and hence, when melting is carried out in an air atmosphere, an undesirable SnO₂ crystal is formed in the surface of a melt or in a melt, and consequently, the initial charge-discharge efficiency lowers and the cycle performance deteriorates. However, if melting is carried out in a reductive atmosphere or an inert atmosphere, the increase of the valence of a Sn ion in the resultant negative electrode active material can be suppressed. As a result, undesirable formation of crystals of, for example, SnO₂ and SnP₂O₇ can be suppressed, and thus an electricity storage device such as a secondary battery excellent in initial charge-discharge efficiency and cycle performance can be provided.

In order to carry out melting in a reductive atmosphere, it is preferred to supply a reductive gas into a melting tank. It is preferred to use, as the reductive gas, a mixed gas including, in terms of vol %, 90 to 99.5% of N₂ and 0.5 to 10% of H₂, and it is particularly preferred to use a mixed gas including 92 to 99% of N₂ and 1 to 8% of H₂.

When melting is carried out in an inert atmosphere, it is preferred to supply an inert gas into a melting tank. It is preferred to use, as the inert gas, any of nitrogen, argon, and helium.

The reductive gas or the inert gas may be supplied into the upper atmosphere of molten glass in a melting tank, or may be directly supplied into molten glass from a bubbling nozzle. Both methods may be carried out at the same time.

Further, the melting temperature is preferably 500° C. to 1300° C. When the melting temperature is higher than 1300° C., the phosphate network in the resultant negative electrode active material is liable to be cut. Besides, isolated phosphates and tin oxide tend to form a crystal, and a SnO component not covered by the phosphate network tends to be decomposed to metal Sn and a SnO₂ crystal, resulting in the reduction of the initial charge-discharge efficiency and the cycle performance. On the other hand, when the melting temperature is lower than 500° C., it is difficult to produce a homogeneous, amorphous material.

Further, in the production method, it is preferred to use a complex oxide containing phosphorus and tin as the starting raw material powder. When the complex oxide containing phosphorus and tin is used as the starting raw material powder, it is easier to produce a negative electrode active material which contains devitrified material at a small ratio and is excellent inhomogeneity. The use of a negative electrode material containing the negative electrode active material as a negative electrode allows the provision of an electricity storage device having a stable discharge capacity. Examples of the complex oxide containing phosphorus and tin include stannous pyrophosphate (Sn₂P2O₇).

A negative electrode active material for an electricity storage device according to Embodiment 3 of the present invention exhibits a full width at half maximum of a diffraction line peak of preferably 0.5° or more, 0.6° or more, 0.7° or more, 0.8° or more, or 0.9° or more, particularly preferably 1° or more, at the time of completion of charge, the diffraction line peak being detected in the range of 30 to 500 in terms of a 2θ value and/or in the range of 10 to 30° in terms of a 2θ value in a diffraction line profile obtained by powder X-ray diffraction measurement using Cu Kα-rays. A full width at half maximum of a diffraction line peak of less than 0.5° means that the crystallite size of a Li_{y}Sn alloy crystal in a negative electrode active material is large and submicron particles (about 100 nm or more) are formed. Thus, when Li ions are released because of a discharge reaction, large volume contraction locally occurs in the negative electrode active material, the negative electrode active material itself is liable to have a crack, the active material itself comes to fine powder and is detached from an electrode at the time of repeated charge and discharge, and consequently, the cycle performance tends to lower. Note that the upper limit of the full width at half maximum of a diffraction line peak is not particularly limited, but realistically, the full width at half maximum is preferably 15° or less, 14° or less, 13.5° or less, 13° or less, or 12.5° or less, particularly preferably 12° or less. A full width at half maximum of a diffraction line peak of more than 150 means that the amount of a Li_{y}Sn alloy crystal formed in a negative electrode active material is small, and consequently, the capacity tends to be smaller.

Further, the negative electrode active material according to Embodiment 3 exhibits a full width at half maximum of a diffraction line peak of preferably 0.1° or more, 0.12° or more, 0.15° or more, 0.2° or more, or 0.3° or more, particularly preferably 0.5° or more, at the time of completion of discharge, diffraction line peak being detected in the range of 15 to 40° in terms of a 2θ value in a diffraction line profile obtained by powder X-ray diffraction measurement using Cu Kα-rays. A full width at half maximum of a diffraction line peak of more than 0.10 means that the crystallite size of a metal Sn crystal in a negative electrode active material is the size of a submicron particle. Thus, when Li ions are stored because of a charge reaction, large volume expansion locally occurs, the active material itself is liable to have a crack, come to fine powder, and be detached from an electrode, and consequently, the cycle performance tends to lower. The upper limit of the full width at half maximum of a diffraction line peak is not particularly limited, but realistically, the full width at half maximum is preferably 15° or less, 14° or less, 13° or less, 12.5° or less, or 12° or less, particularly preferably 11° or less. A full width at half maximum of a diffraction line peak of more than 15° means that the amount of metal Sn formed in a negative electrode active material is small, and consequently, the capacity tends to be smaller.

The negative electrode active material for an electricity storage device according to Embodiment 3 preferably comprises, as a composition in terms of mol % on the oxide basis, 10 to 70% of SnO, 20 to 70% of Li₂O, and 2 to 40% of P₂O₅ at the time of completion of discharge. The reasons why the content of each component is defined as mentioned above are described below.

SnO is an active material component serving as a site for storing and releasing Li ions in a negative electrode active material. The content of SnO is preferably 10 to 70%, 12 to 68%, or 14 to 66%, particularly preferably 16 to 64%. When the content of SnO is less than 10%, the capacity per unit mass of the resultant negative electrode active material becomes smaller. When the content of SnO is more than 70%, the amount of amorphous components in the resultant negative electrode active material becomes smaller, and hence it is not possible to abate a volume change attributed to the storage and release of Li ions at the time of charge and discharge, possibly resulting a sharp reduction in discharge capacity.

Li₂O has a role of improving the Li ion conductivity of the negative electrode active material. The content of Li₂O is preferably 20 to 70%, 22 to 68%, or 24% to 66%, particularly preferably 25% to 65%. When the content of Li₂O is less than 20%, the Li ion conductivity lowers, probably resulting in the reduction of the discharge capacity. When the content of Li₂O is more than 70%, the size of a Sn—Li alloy or a Sn metal particle becomes larger, probably resulting in the reduction of the cycle performance.

P₂O₅ is a network-forming oxide, covers a site of a SnO component for storing and releasing lithium ions, and functions as a solid electrolyte in which lithium ions are movable. The content of P₂O₅ is preferably 2 to 40%, 3 to 38%, or 4 to 36%, particularly preferably 5 to 35%. When the content of P₂O₅ is less than 2% in a negative electrode active material, it is not possible to abate the change of the volume of a SnO component attributed to the storage and release of Li ions at the time of charge and discharge, resulting in its structural degradation, and hence the discharge capacity is liable to lower at the time of repeated charge and discharge. When the content of P₂O₅ is more than 40%, the discharge capacity per unit mass of the resultant negative electrode active material tends to lower, and moreover, its water resistance is liable to deteriorate, and consequently, undesirable other crystals (such as SnHPO₄) may be produced after exposure to high temperature and high humidity for a long period, or the negative electrode active material is liable to be impregnated with or adsorb moisture. As a result, in an electricity storage device using the negative electrode active material, water splits, releasing oxygen and resulting in its explosion, or heat is produced through a reaction between lithium and water, causing ignition, and hence the negative electrode active material has inferior safety.

The negative electrode active material for an electricity storage device according to Embodiment 3 is formed of a material containing at least SnO and P₂O₅ as its composition before initial charge (at the time of installing a battery). The content of each of these components is adjusted, for example, to the range of 45 to 95% for SnO and the range of 5 to 55% for P₂O₅.

SnO is an active material component serving as a site for storing and releasing Li ions in a negative electrode active material. The content of SnO is, in terms of mol %, preferably 45 to 95% or 50 to 90%, particularly preferably 55 to 85%. When the content of SnO is less than 45%, the capacity per unit mass of the resultant negative electrode active material becomes smaller. When the content of SnO is more than 95%, the amount of amorphous components in the resultant negative electrode active material becomes smaller, and hence it is not possible to abate a volume change attributed to the storage and release of Li ions at the time of charge and discharge, possibly resulting in a sharp reduction in discharge capacity.

P₂O₅ is a network-forming oxide, covers a site of SnO for storing and releasing Li ions, and functions as a solid electrolyte in which Li ions are movable. The content of P₂O₅ is, in terms of mol %, preferably 5 to 55% or 10 to 50%, particularly preferably 15 to 45%. When the content of P₂O₅ is less than 5% in a negative electrode active material, it is not possible to abate the change of the volume of SnO attributed to the storage and release of Li ions at the time of charge and discharge, resulting in its structural degradation, and hence the discharge capacity is liable to reduce significantly at the time of repeated charge and discharge. When the content of P₂O₅ is more than 55%, a stable crystal (such as SnP₂O₇) is easily formed together with a Sn atom, bringing about such a state that the influence of the coordinate bonds to a Sn atom by lone pairs of electrons owned by each oxygen atom existing in chained P₂O₅ is more intensified. As a result, the initial charge-discharge efficiency tends to lower.

The molar ratio of SnO to P₂O₅ (SnO/P₂O₅) in the negative electrode active material is preferably 0.8 to 19 or 1 to 18, particularly preferably 1.2 to 17. When the SnO/P₂O₅ is less than 0.8, the Sn atom in SnO is liable to be influenced by the coordination of P₂O₅, with the result that the initial charge-discharge efficiency tends to reduce. On the other hand, when the SnO/P₂O₅ is more than 19, the discharge capacity is liable to lower at the time of repeated charge and discharge. This is probably because the number of P₂O₅ coordinating to SnO decreases in the resultant negative electrode active material, P₂O₅ cannot cover SnO sufficiently, and consequently, it is not possible to abate the change of the volume of SnO attributed to the storage and release of Li ions, causing its structural degradation.

Besides, various components can be further added to the negative electrode active material according to Embodiment 3 (at the time of mounting on an electricity storage device), in addition to the above-mentioned components. For example, CuO, ZnO, B₂O₃, MgO, CaO, Al₂O₃, SiO₂, and R₂O (R represents Li, Na, K, or Cs) are contained at a total content of preferably 0 to 20% or 0 to 10%, particularly preferably 0 to 7%. When the total content is more than 20%, vitrification easily occurs, but a phosphate network is liable to be cut, resulting in the degradation of the cycle performance.

The negative electrode active material for an electricity storage device according to Embodiment 3 is produced by, for example, melting raw material powder under heating at 500 to 1300° C., thereby causing the vitrification thereof. Here, the melting of the raw material powder is preferably carried out in a reductive atmosphere or an inert atmosphere.

In an oxide containing Sn, the oxidation state of a Sn atom easily changes depending on melting conditions, and hence, when melting is carried out in an air atmosphere, an undesirable SnO₂ crystal is formed in the surface of a melt or in a melt, and consequently, the initial charge-discharge efficiency lowers and the cycle performance deteriorates. However, if melting is carried out in a reductive atmosphere or an inert atmosphere, the increase of the valence of a Sn ion in the resultant negative electrode active material can be suppressed. As a result, undesirable formation of crystals of, for example, SnO₂ and SnP₂O₇ can be suppressed, and thus a secondary battery excellent in initial charge-discharge efficiency and cycle performance can be provided.

Further, in the production method, it is preferred to use a complex oxide containing phosphorus and tin as the starting raw material powder. When the complex oxide containing phosphorus and tin is used as the starting raw material powder, it is easier to produce a negative electrode active material which contains devitrified material at a small ratio and is excellent in homogeneity. The use of a negative electrode material containing the negative electrode active material as a negative electrode allows the provision of an electricity storage device having a stable discharge capacity. Examples of the complex oxide containing phosphorus and tin include stannous pyrophosphate (Sn₂P2O₇).

Note that the negative electrode of an electricity storage device such as a non-aqueous secondary battery is formed by using a negative electrode material containing any of the negative electrode active materials of the embodiments described above. Specifically, the negative electrode material is formed by adding, to the negative electrode active material, a binder such as a thermosetting resin, and a conductive agent such as acetylene black, ketjen black, highly conductive carbon black, or graphite.

A negative electrode active material for an electricity storage device according to Embodiment 4 of the present invention is such that a difference (Pl−Pm) between the binding energy value Pl of an electron on the Sn 3d_{5/2} orbital of a Sn atom in the negative electrode active material and the binding energy value Pm of an electron on the Sn 3d_{5/2} orbital of metal Sn is 0.01 to 3.5 eV. A difference (Pl−Pm) of less than 0.01 eV means that almost all Sn atoms are not bonded to any other atoms and are present in a state of having a structure similar to that of metal Sn. When Sn atoms are present in a state similar to that of metal Sn in a negative electrode active material, a Sn component is liable to be present as an aggregate in the negative electrode active material. When such state is established, the storage and release of lithium ions occur locally at the time of repeated charge and discharge, and hence a remarkable change of the volume of the negative electrode active material cannot be abated and the structure of the negative electrode active material is easily broken. As a result, the discharge capacity tends to lower significantly at the time of repeated use. On the other hand, when (Pl−Pm) is more than 3.5 eV, it is required, at the time of initial charge, to use an excessive amount of electrons necessary for reducing Sn atoms in the resultant negative electrode material to metal Sn and an excessive amount of lithium ions for charge compensation, and hence the initial charge-discharge efficiency remarkably lowers. The range of the binding energy difference (Pl−Pm) is preferably 0.05 to 3.4 eV or 0.1 to 3.35 eV, more preferably 0.12 to 3.3 eV.

The negative electrode active material for an electricity storage device according to Embodiment 4 comprises at least SnO as its composition. SnO is an active material component serving as a site for storing and releasing lithium ions in the negative electrode active material. The content of SnO is, in terms of mol %, preferably 45 to 95% or 50 to 90%, particularly preferably 55 to 85%. When the content of SnO is less than 45%, the capacity per unit mass of the resultant negative electrode active material becomes smaller. When the content of SnO is more than 95%, the amount of amorphous components in the resultant negative electrode active material becomes smaller, it is thus impossible to abate a volume change attributed to the storage and release of lithium ions at the time of charge and discharge, and consequently, a sharp reduction in discharge capacity may occur.

Components for the above-mentioned negative electrode active material include P₂O₅ in addition to SnO. P₂O₅ is a network-forming oxide, covers a site of SnO for storing and releasing lithium ions, and functions as a solid electrolyte in which lithium ions are movable. The content of P₂O₅ is, in terms of mol %, preferably 5 to 55% or 10 to 50%, particularly preferably 15 to 45%. When the content of P₂O₅ is less than 5% in a negative electrode active material, it is not possible to abate the change of the volume of SnO attributed to the storage and release of lithium ions at the time of charge and discharge, resulting in its structural degradation, and hence the discharge capacity is liable to reduce significantly at the time of repeated charge and discharge. When the content of P₂O₅ is more than 55%, a stable crystal (such as SnP₂O₇) is easily formed together with a Sn atom, bringing about such a state that the binding of the electrons on the 3d_{5/2} orbital of the Sn atom is stronger, and hence, the binding energy value Pl becomes larger. As a result, the binding energy difference (Pl−Pm) becomes larger, and hence the initial charge-discharge efficiency tends to lower.

The molar ratio of SnO to P₂O₅ (SnO/P₂O₅) is preferably 0.8 to 19 or 1 to 18, particularly preferably 1.2 to 17. When the SnO/P₂O₅ is less than 0.8, the Sn atom in SnO is liable to be influenced by the coordination of P₂O₅, the binding energy between each core electron on the 3d_{5/2} orbital of the Sn atom and its nucleus is stronger, and hence, the binding energy value Pl becomes larger. As a result, the binding energy difference (Pl−Pm) becomes larger, and hence the initial charge-discharge efficiency tends to lower. On the other hand, when the SnO/P₂O₅ is more than 19, the discharge capacity is liable to lower significantly at the time of repeated charge and discharge. This is probably because the number of P₂O₅ coordinating to SnO decreases in the resultant negative electrode active material, P₂O₅ cannot cover SnO, and consequently, it is not possible to abate the change of the volume of SnO attributed to the storage and release of lithium ions, causing its structural degradation.

Besides, various components can be further added in addition to the above-mentioned components. For example, CuO, ZnO, B₂O₃, MgO, CaO, Al₂O₃, SiO₂, and R₂O (R represents Li, Na, K, or Cs) can be contained. These components each have a role of improving the cycle performance.

The negative electrode active material for an electricity storage device according to Embodiment 4 is formed of an amorphous substance and/or a crystalline substance containing, for example, a plurality of oxide components as its composition. The negative electrode active material has a crystallinity of preferably 95% or less, 80% or less, 70% or less, or 50% or less, particularly preferably 30% or less, and is most preferably substantially amorphous. As a negative electrode active material containing SnO at a high ratio has a smaller crystallinity (has a larger ratio of an amorphous phase), the change of its volume at the time of repeated charge and discharge is more abated, and hence having a smaller crystallinity is advantageous from the viewpoint of suppressing the reduction of a discharge capacity.

The crystallinity of a negative electrode active material is determined by performing peak separation to each crystalline diffraction line and an amorphous halo in a diffraction line profile ranging from 10 to 60° in terms of a 2θ value obtained by powder X-ray diffraction measurement using Cu Kα-rays. Specifically, when an integral intensity obtained by performing the peak separation of a broad diffraction line (amorphous halo) in the range of 10 to 40° from a total scattering curve obtained by performing background subtraction from the diffraction line profile is defined as Ia, and the total sum of integral intensities obtained by performing the peak separation of each crystalline diffraction line detected in the range of 10 to 60° from the total scattering curve is defined as Ic, the crystallinity Xc can be calculated on the basis of the following equation.

Xc=[Ic/(Ic+Ia)]×100

The negative electrode active material according to Embodiment 4 may contain a phase formed of a complex oxide of a metal and an oxide or an alloy phase of a metal and another metal.

Note that, after an electricity storage device using the negative electrode active material according to Embodiment 4 is charged and discharged, the negative electrode active material contains lithium oxides, a Sn—Li alloy, or metal tin in some cases.

Examples of the form of the negative electrode active material according to Embodiment 4 include a powder form and a bulk form. The form is not particularly limited, but a powder form is advantageous because the specific surface area of the negative electrode active material is enlarged, thereby being able to increase its capacity.

As for its diameter, the powder has preferably an average particle diameter of 0.1 to 10 μm and a maximum particle diameter of 75 μm or less, an average particle diameter of 0.3 to 9 μm and a maximum particle diameter of 65 μm or less, or an average particle diameter of 0.5 to 8 μm and a maximum particle diameter of 55 μm or less, particularly preferably an average particle diameter of 1 to 5 μm and a maximum particle diameter of 45 μm or less. If powder having an average particle diameter of more than 10 μm or a maximum particle diameter of more than 75 μm is used, the resultant negative electrode material is liable to be detached from a current collector owing to a volume change attributed to the storage and release of Li ions at the time of charge and discharge. As a result, repeated charge and discharge tends to cause the capacity to be remarkably reduced. On the other hand, if powder having an average particle diameter of less than 0.1 μm is used, the powder is poorly dispersed when formed into a paste, and hence it tends to be difficult to produce a homogeneous electrode.

Note that the average particle diameter and the maximum particle diameter denote D50 (particle diameter at 50% in the volume cumulative distribution) and D100 (particle diameter at 100% in the volume cumulative distribution), respectively, in the median diameter of primary particles, and refer to values obtained by measurement with a laser diffraction particle size analyzer.

Further, the specific surface area of the powder measured by a BET method is preferably 0.1 to 20 m²/g or 0.15 to 15 m²/g, particularly preferably 0.2 to 10 m²/g. If powder having a specific surface area of less than 0.1 m²/g is used, the storage and release of Li ions cannot be performed rapidly and charge and discharge times tend to be longer. On the other hand, if powder having a specific surface area of more than 20 m²/g is used, the powder is liable to attract static electricity, the powder is poorly dispersed when formed into a paste, and hence it tends to be difficult to produce a homogeneous electrode.

Further, the tap density of the powder is preferably 0.5 to 2.5 g/cm³, particularly preferably 1.0 to 2.0 g/cm³. If the powder has a tap density of less than 0.5 g/cm³, the filling amount per electrode unit volume of the negative electrode active material is small, electrode density is thus poor, and hence it becomes difficult to attain a high capacity. On the other hand, if the powder having a tap density of more than 2.5 g/cm³, the filling state of the negative electrode active material is too high for an electrolytic solution to penetrate easily, and consequently, a sufficient capacity may not be provided.

Note that the tap density herein refers to a value obtained by measurement under the conditions of a tapping stroke of 18 mm, a number of taps of 180, and a tapping rate of 1 tap/second.

In order to produce powder having predetermined sizes, a general grinding mill or classifier is used. There is used, for example, a mortar, a ball mill, a vibration ball mill, a satellite ball mill, a planetary ball mill, a jet mill, a sieve, a centrifuge, or an air classifier.

The negative electrode active material for an electricity storage device according to Embodiment 4 is produced by, for example, melting raw material powder under heating, thereby causing vitrification thereof. Here, the raw material powder is preferably melted in a reductive atmosphere or an inert atmosphere.

In an oxide containing Sn, the oxidation state of a Sn atom easily changes depending on melting conditions, and hence the binding energy of an electron easily changes. It is possible to decrease the valence of a Sn ion in a negative electrode material by, for example, carrying out melting in a reductive atmosphere or an inert atmosphere. As a result, (Pl−Pm) can be reduced as described previously, and hence it is possible to obtain an electricity storage device excellent in initial charge-discharge efficiency.

In order to carry out melting in a reductive atmosphere, it is preferred to supply a reductive gas into a melting tank. It is preferred to use, as the reductive gas, a mixed gas including, in terms of vol %, 90 to 99.5% of N₂ and 0.5 to 10% of H₂, and it is particularly preferred to use a mixed gas including 92 to 99% of N₂ and 1 to 8% of H₂.

When melting is carried out in an inert atmosphere, it is preferred to supply an inert gas into a melting tank. It is preferred to use, as the inert gas, any of nitrogen, argon, and helium. The reductive gas or the inert gas may be supplied into the upper atmosphere of molten glass in a melting tank, or may be directly supplied into molten glass from a bubbling nozzle. Both methods may be carried out at the same time.

In the method of producing the negative electrode active material for an electricity storage device according to Embodiment 4, it is preferred that the raw material powder include metal powder or carbon powder. With this, Sn atoms in the negative electrode active material can be shifted to those in a reductive state to reduce Pl. As a result, the value of (Pl−Pm) in the negative electrode active material becomes smaller, and thus it is possible to improve the initial charge-discharge efficiency of the resultant electricity storage device.

It is preferred to use, as the metal powder, powder of any of Sn, Al, Si, and Ti. Of those, powder of Sn or Al is preferably used.

The content of the metal powder is, in terms of mol %, preferably 0 to 20%, particularly preferably 0.1 to 10%. If the content of the metal powder is more than 20%, an excess metal precipitates as a lump from the resultant negative electrode material, or SnO in the resultant negative electrode active material is reduced and Sn particles having a metal state may precipitate.

As for the content of the carbon powder, the carbon powder is added at preferably 0 to 20 mass %, particularly preferably 0.05 to 10 mass % in the raw material powder.

Further, in the production method, it is preferred to use a complex oxide containing phosphorus and tin as the starting raw material powder. When the complex oxide containing phosphorus and tin is used as the starting raw material powder, it is easier to produce a negative electrode active material which contains devitrified material at a small ratio and is excellent in homogeneity. The use of the negative electrode active material as an electrode allows the provision of an electricity storage device having a stable discharge capacity. Examples of the complex oxide containing phosphorus and tin include stannous pyrophosphate (Sn₂P2O₇).

Note that the negative electrode of an electricity storage device such as a non-aqueous secondary battery is formed by using a negative electrode material containing the negative electrode active material described above. Specifically, the negative electrode material is formed by adding, to the negative electrode active material, a binder such as a thermosetting resin, and a conductive agent such as acetylene black, ketjen black, highly conductive carbon black, and graphite.

Further, the negative electrode active material and negative electrode material of the present invention can be applied not only to a lithium ion secondary battery but also to other non-aqueous secondary batteries and to, for example, a hybrid capacitor in which a positive electrode material for a non-aqueous electric double layer capacitor and a negative electrode material for a lithium ion secondary battery are combined.

A lithium ion capacitor, which is a hybrid capacitor, is a kind of asymmetric capacitor, in which the charge-discharge principle of a positive electrode and that of a negative electrode are different. The lithium ion capacitor has a structure in which a negative electrode for a lithium ion secondary battery and a positive electrode for an electric double layer capacitor are combined. Here, the positive electrode is charged and discharged through a physical action (static electricity action) of an electric double layer formed on its surface, whereas the positive electrode is charged and discharged through chemical reactions (storage and release) of lithium ions, in the same manner as in a lithium ion secondary battery described previously.

There is used, for the positive electrode of the lithium ion capacitor, a positive electrode material formed of, for example, carbonaceous powder having a high specific surface area, such as powder of activated carbon, a polyacene, or mesophase carbon. On the other hand, it is possible to use, for the negative electrode, a material produced by storing lithium ions and electrons in the negative electrode material of the present invention.

There is no particular limitation to means for storing lithium ions and electrons in the negative electrode active material of the present invention. For example, it is possible that a metal lithium electrode serving as supply sources of lithium ions and electrons is provided in a capacitor cell and is brought into contact with a negative electrode containing the negative electrode active material of the present invention directly or through an electric conductor, or it is possible that lithium ions and electrons are preliminarily stored in the negative electrode active material of the present invention in another cell and the cell is installed in a capacitor cell.

### Example 1

Hereinafter, the negative electrode active material for an electricity storage device according to Embodiment 1 is described in detail by way of examples, but the present invention is not limited to these examples.

(1) Preparation of Negative Electrode Active Material for Non-Aqueous Secondary Battery

Table 1 shows Examples 1 to 6 and Comparative Examples 1 to 3. Each negative electrode active material was prepared as follows.

Raw material powder was prepared by using stannous pyrophosphate (Sn₂P2O₇) as the main raw material together with various oxides, a phosphate raw material, a carbonate raw material, a metal, a carbon raw material, and the like, so that each composition shown in Table 1 was attained. The raw material powder was fed into an alumina crucible and was melted in a nitrogen atmosphere at 950° C. for 40 minutes by using an electric furnace, causing vitrification thereof.

Next, the molten glass was poured between a pair of rotating rollers and was formed into a film having a thickness of 0.1 to 2 mm while being quenched, thus obtaining each glass sample. The each glass sample was pulverized with an alumina stirring grinder, and the pulverized glass sample was then passed through a sieve having a mesh size of 20 μm, obtaining glass powder having an average particle diameter of 5 μm (a negative electrode active material for a non-aqueous secondary battery).

Each sample was subjected to powder X-ray diffraction measurement, thereby identifying its structure. All negative electrode active materials of Examples 1 to 6 except Example 5 were amorphous and no crystal was detected. Precipitation of a fine crystal of SnO₂ was confirmed in the amorphia of Example 5, and the crystallinity Xc thereof was 4%. The negative electrode active material of Comparative Example 1 had deliquescent property immediately after its production, and hence measurement of a precipitated crystal was impossible. The negative electrode active materials of Comparative Examples 2 and 3 each had a structure in which amorphous parts and crystal parts were mixed.

(2) Preparation of Negative Electrode

The glass powder (negative electrode active material) of each of the examples and comparative examples, a polyimide resin as a binder, and ketjen black as a conductive material were weighed so as to satisfy glass powder:binder:conductive material=85:10:5 (mass ratio), and these were dispersed in N-methylpyrrolidone (NMP), followed by sufficient stirring with a rotation-revolution mixer, obtaining a slurry-like negative electrode material. Next, a doctor blade with an gap of 150 μm was used to coat a copper foil having a thickness of 20 μm and serving as a negative electrode current collector with the resultant slurry, and the coated copper foil was dried at 70° C. with a dryer and was then passed through and pressed between a pair of rotating rollers, obtaining an electrode sheet. An electrode punching machine was used to punch a piece having a diameter of 11 mm out of the electrode sheet, and the piece was imidized at 200° C. for 10 hours under reduced pressure, obtaining a circular working electrode.

(3) Preparation of Test Battery

The working electrode was placed with its copper foil surface facing downward on a lower lid of a coin cell, and there were laminated, on the working electrode, a separator formed of a polypropylene porous film (Celgard #2400 manufactured by Hoechst Celanese Corporation) having a diameter of 16 mm, which had been dried under reduced pressure at 60° C. for 8 hours, and metal lithium serving as an opposite electrode, thus preparing a test battery. Used as an electrolytic solution was a 1 M LiPF₆ solution/ethylene carbonate (EC):diethyl carbonate (DEC)=1:1. Note that the assembly of the test battery was carried out in an environment of a dew-point temperature of −60° C. or less.

(4) Charge-Discharge Test

Charge (storage of lithium ions in a negative electrode active material) was carried out by 0.2 mA constant current (CC) charge from 2 V to 0 V. Next, discharge (release of lithium ions from the negative electrode active material) was carried out by discharge at a constant current of 0.2 mA from 0 V to 2 V. This charge-discharge cycle was repeated.

Table 1 shows the results of initial charge-discharge performance and the results of cycle performance when repeated charge and discharge was carried out in the charge-discharge test for the respective samples.

TABLE 1

| | | Example | | | | | | Comparative Example | | |
|---|---|---|---|---|---|---|---|---|---|---|
| | | 1 | 2 | 3 | 4 | 5 | 6 | 1 | 2 | 3 |
| Composition | SnO | 70.5 | 73 | 78 | 83 | 88 | 70.5 | 30 | 40 | 96 |
| [mol %] | P₂O₅ | 29.5 | 27 | 22 | 17 | 12 | 26.5 | 70 | 60 | 4 |
| | Li₂O | | | | | | 3 | | | |
| | SnO + P₂O₅ | 100 | 100 | 100 | 100 | 100 | 97 | 100 | 100 | 100 |
| | SnO/P₂O₅ | 2.4 | 2.7 | 3.5 | 4.9 | 7.3 | 2.7 | 0.4 | 0.7 | 24.0 |
| Precipitated crystal | | Absent | Absent | Absent | Absent | SnO₂ | Absent | — | SnP₂O₇ | SnO₂ SnO |
| (Crystallinity %) | | (0) | (0) | (0) | (0) | (4) | (0) | | (24) | (65) |
| Charge-discharge | Initial | 1136 | 1126 | 1142 | 1172 | 1245 | 1096 | Unmeasurable | 943 | 1303 |
| performance | charge capacity | | | | | | | | | |
| [mAh/g] | Initial | 680 | 685 | 696 | 743 | 856 | 681 | | 392 | 901 |
| | discharge capacity | | | | | | | | | |
| | Discharge capacity | 538 | 561 | 396 | 382 | 394 | 520 | | 258 | 52 |
| | at 50th cycle | | | | | | | | | |

The initial discharge capacity of the battery using the negative electrode active material of each of Examples 1 to 6 was 680 mAh/g or more and the discharge capacity thereof at the 50th cycle was as good as 382 mAh/g or more. On the other hand, the negative electrode active material of Comparative Example 1 had deliquescent property immediately after its production, and hence was not able to be used as an electrode for a non-aqueous secondary battery. The initial discharge capacity of the battery using the negative electrode active material of Comparative Example 2 was as low as 392 mAh/g. Further, the initial discharge capacity of the battery using the negative electrode active material of Comparative Example 3 was 901 mAh/g, but the discharge capacity thereof at the 50th cycle was as remarkably low as 52 mAh/g.

### Example 2

Hereinafter, the negative electrode active material for an electricity storage device according to Embodiment 2 is described in detail by way of examples, but the present invention is not limited to these examples.

(1) Preparation of Negative Electrode Active Material for Non-Aqueous Secondary Battery

Tables 2 and 3 show Examples 1 to 6 and Comparative Examples 1 and 2. Each negative electrode active material was prepared as follows.

Raw material powder was prepared by using a complex oxide of tin and phosphorus (stannous pyrophosphate:Sn₂P2O₇) as the main raw material together with various oxides, a carbonate raw material, and the like, so that each composition shown in Tables 2 and 3 was attained. The raw material powder was fed into a quartz crucible and was melted in a nitrogen atmosphere at 950° C. for 40 minutes by using an electric furnace, causing vitrification thereof.

Next, the molten glass was poured between a pair of rotating rollers and was formed, while being quenched, into a film-shaped glass having a thickness of 0.1 to 2 mm. The film-shaped glass was fed into a ball mill using zirconia balls with diameters of 2 to 3 cm and was pulverized at 100 rpm for 3 hours, and the pulverized glass was then passed through a resin sieve having a mesh size of 120 μm, obtaining glass coarse powder having an average particle diameter D₅₀ of 8 to 15 μm. Next, the glass coarse powder was fed into a ball mill using zirconia balls each with a diameter of 5 mm, ethanol was added thereto, and the glass coarse powder was pulverized at 40 rpm for 5 hours, followed by drying at 200° C. for 4 fours, obtaining glass powder having an average particle diameter of 2 to 5 μm (a negative electrode active material for a non-aqueous secondary battery).

Each sample was subjected to powder X-ray diffraction measurement to identify its crystal structure. The negative electrode active materials of Examples 1 to 4 and 6 were amorphous and no crystal was detected. Example 5 was almost amorphous, but a crystal was partially detected.

(2) Powder X-Ray Diffraction (Powder XRD) Measurement

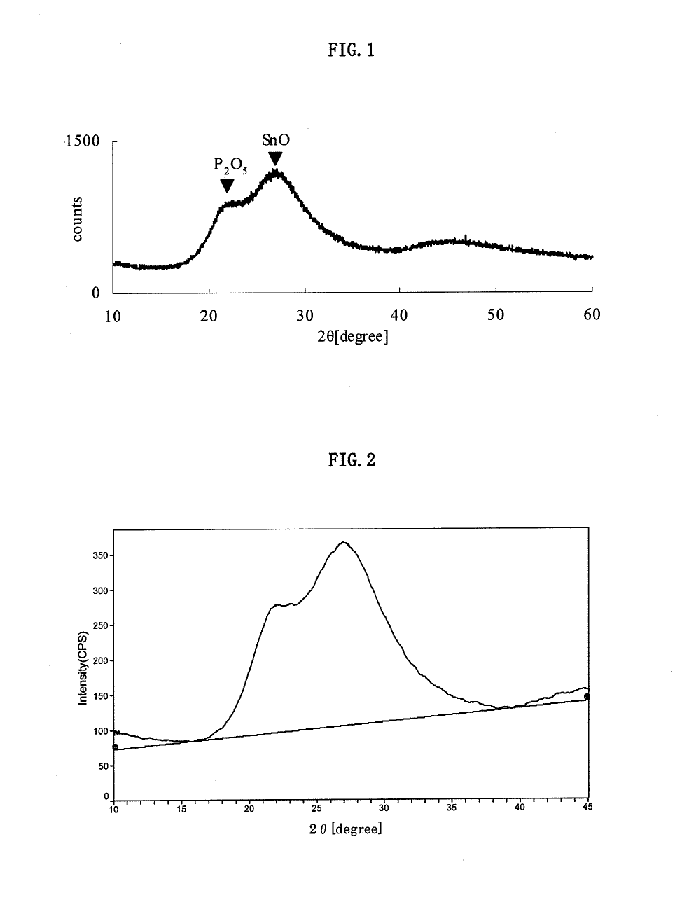

Each sample was measured by using RINT 2000 manufactured by Rigaku Corporation as a powder X-ray diffraction measurement apparatus and using Cu Kα-rays as a X-ray source under the following conditions, thereby yielding a diffraction line profile (see FIG. 1).

Tube voltage/tube current: 40 kV/40 mA

Divergence/scattering slit: 1°
Receiving slit: 0.15 mm
Sampling width: 0.01°
Measurement range: 10 to 60°
Measurement rate: 0.1°/sec
Cumulative number: 5

(3) Analysis and Data Analysis

JADE Ver. 6.0 manufactured by Materials Data, Inc. was used as analysis software to carry out the data analysis of the diffraction line profile according to the following procedure.

(a) First, in a diffraction line profile in the range of 10 to 60°, an amorphous halo except crystalline diffraction lines was smoothed. Specifically, a parabolic filter was used to perform smoothing with a data point number of 99 based on the Savitzky-Golay filter method, and then the range of 10 to 45° in terms of 2θ was trimmed. A straight-line fit was made to the diffraction line profile (see FIG. 2) so that the intensity of the diffraction line profile did not have a minus value in the range, and background subtraction was performed.

(b) In the diffraction line profile obtained by performing background subtraction, a peak component P1 was prepared by fixing the 2θ value of its apex to 22.5° and a peak component P2 was prepared on the higher angle side than 22.5° without fixing its apex (Here, the peak component P1 derives from a phosphate component in a negative electrode material. The peak component P2 derives from a tin component in the negative electrode material, and the 2θ value corresponding to the apex reflects the oxidation state of tin.). Note that, when a crystalline diffraction line was found in the diffraction line profile in the range of 10 to 45° in terms of 2θ, a peak component of a crystalline diffraction line in which the apex and an asymmetric parameter were not fixed was added.

(c) Curve fitting was performed for the peak components P1 and P2 with the pseudo-Voight function. Here, the asymmetric parameters of the peak components P1 and P2 were fixed to −0.75 and −0.55, respectively, so that the peak components P1 and P2 were able to be determined unambiguously by the curve fitting.

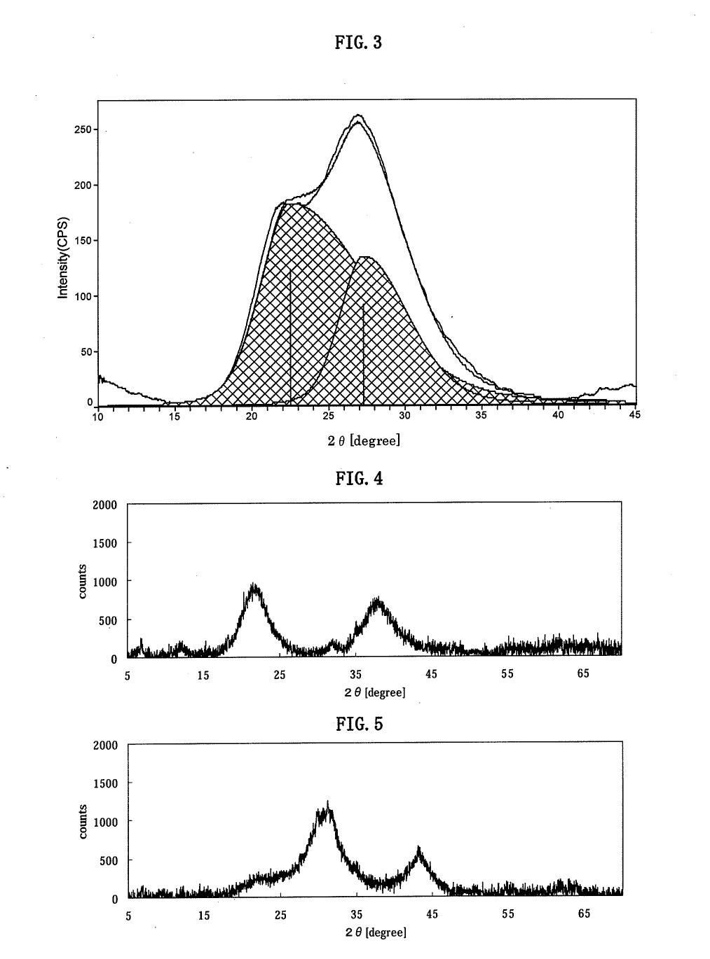

(d) The data was repeatedly refined so that the fitting residual between the diffraction line profile and the curve obtained by the curve fitting came to 22% or less and the full width at half maximum (FWHM) of the peak of each of the peak components P1 and P2 fell within the range of 2 to 20 (see FIG. 3).

(e) There were determined the 2θ value of the apex of the peak component P2 and the peak areas A1 and A2 of the peak components P1 and P2, respectively.

(4) Preparation of Negative Electrode

Each glass powder (negative electrode active material) obtained above, a polyimide resin as a binder, and ketjen black as a conductive material were weighed so as to satisfy a ratio of glass powder:binder:conductive material=85:10:5 (weight ratio), and were dispersed in N-methylpyrrolidone (NMP), followed by sufficient stirring with a rotation-revolution mixer, obtaining a slurry-like negative electrode material. Next, a doctor blade with an gap of 150 μm was used to coat a copper foil having a thickness of 20 μm and serving as a negative electrode current collector with the resultant slurry, and the coated copper foil was dried at 70° C. with a dryer and was then passed through and pressed between a pair of rotating rollers, obtaining an electrode sheet. An electrode punching machine was used to punch a piece having a diameter of 11 mm out of the electrode sheet, and the piece was dried at 200° C. for 10 hours under reduced pressure so that the polyimide resin was imidized, obtaining a circular working electrode.

(5) Preparation of Test Battery

The working electrode was placed with its copper foil surface facing downward on a lower lid of a coin cell, and there were laminated, on the working electrode, a separator formed of a polypropylene porous film (Celgard #2400 manufactured by Hoechst Celanese Corporation) having a diameter of 16 mm, which had been dried under reduced pressure at 60° C. for 8 hours, and metal lithium serving as an opposite electrode, thus producing a test battery. Used as an electrolytic solution was a 1 M LiPF₆ solution/EC:DEC=1:1 (EC=ethylene carbonate, DEC=diethyl carbonate). Note that the assembly of the test battery was carried out in an environment of a dew-point temperature of −60° C. or less.

(6) Charge-Discharge Test

Charge (storage of lithium ions in a negative electrode material) was carried out by 0.2 mA constant current (CC) charge from 2 V to 0 V. Next, discharge (release of lithium ions from the negative electrode material) was carried out by discharge at a constant current of 0.2 mA from 0 V to 2 V. This charge-discharge cycle was repeated.

Tables 2 and 3 show the results of initial charge-discharge performance and the results of cycle performance when repeated charge and discharge was carried out in the charge-discharge test for the batteries using the negative electrode active materials of the examples and comparative examples.

TABLE 2

| | | Example | | | | | |
|---|---|---|---|---|---|---|---|
| | | 1 | 2 | 3 | 4 | 5 | 6 |
| Composition | SnO | 68 | 71 | 76 | 81 | 86 | 68 |
| [mol %] | P₂O₅ | 32 | 29 | 24 | 19 | 14 | 22.5 |
| | Al₂O₃ | | | | | | 1 |
| | B₂O₃ | | | | | | 7 |
| | MgO | | | | | | 1.5 |
| | SnO/P₂O₅ | 2.1 | 2.4 | 3.2 | 4.3 | 6.1 | 3.0 |
| Precipitated crystal | | — | — | — | — | SnO₂ | — |
| (Crystallinity [%]) | | 0 | 0 | 0 | 0 | (4) | 0 |
| Results of XRD | Peak position | 26.49 | 27.28 | 27.42 | 27.39 | 27.61 | 27.25 |
| characteristic | of P2 [°] | | | | | | |
| | Peak area A1 | 34.0 | 11.5 | 24.7 | 8.4 | 1.3 | 4.2 |
| | of P1 [×10⁴] | | | | | | |
| | Peak area A2 | 9.6 | 5.4 | 29.0 | 29.0 | 48.5 | 3.3 |
| | of P2 [×10⁴] | | | | | | |
| | A1/A2 | 3.53 | 2.13 | 0.85 | 0.29 | 0.03 | 1.26 |
| Charge-discharge | Initial charge | 1146 | 1123 | 1141 | 1168 | 1233 | 1133 |
| performance | capacity [mAh/g] | | | | | | |
| | Initial discharge | 670 | 680 | 692 | 729 | 826 | 691 |
| | capacity [mAh/g] | | | | | | |
| | Initial charge-dis- | 58.5 | 60.6 | 60.6 | 62.4 | 67.0 | 61.0 |
| | charge efficiency [%] | | | | | | |
| | Discharge capacity | 541 | 556 | 421 | 424 | 411 | 514 |
| | at 50th cycle [mAh/g] | | | | | | |

TABLE 3

| | | Comparative Example | |
|---|---|---|---|
| | | 1 | 2 |
| Composition | SnO | 40 | 96 |
| [mol %] | P₂O₅ | 60 | 4 |
| | Al₂O₃ | | |
| | B₂O₃ | | |
| | MgO | | |
| | SnO/P₂O₅ | 0.7 | 24 |
| Precipitated crystal (Crystallinity [%]) | | SnP₂O₇ | SnO₂, SnO |
| | | (24) | (96) |
| XRD | Peak position of P2 [°] | 24.92 | 29.36 |
| characteristic | Peak area A1 of P1 | 33.0 | 0.13 |
| | [×10⁴] | | |
| | Peak area A2 of P2 | 3.0 | 34.3 |
| | [×10⁴] | | |
| | A1/A2 | 11.0 | 0.004 |
| Charge- | Initial charge capacity | 943 | 1303 |
| discharge | [mAh/g] | | |
| performance | Initial discharge | 392 | 901 |
| | capacity [mAh/g] | | |
| | Initial charge-discharge | 41.6 | 69.1 |
| | efficiency [%] | | |
| | Discharge capacity at | 258 | 52 |
| | 50th cycle [mAh/g] | | |

The initial discharge capacity of the battery using the negative electrode active material of each of Examples 1 to 6 was 670 mAh/g or more and the discharge capacity thereof at the 50th cycle was as good as 411 mAh/g or more. On the other hand, the initial discharge capacity of the battery using the negative electrode active material of Comparative Example 1 was as low as 392 mAh/g. Further, the initial discharge capacity of the battery using the negative electrode active material of Comparative Example 2 was 901 mAh/g, but the discharge capacity thereof at the 50th cycle was as remarkably low as 52 mAh/g.

### Example 3

Hereinafter, the negative electrode active material for an electricity storage device according to Embodiment 3 is described in detail by way of examples, but the present invention is not limited to these examples.

(1) Preparation of Negative Electrode Active Material for Non-Aqueous Secondary Battery

Raw material powder was prepared by using a complex oxide of tin and phosphorus (stannous pyrophosphate:Sn₂P2O₇) as the main raw material together with various oxides, a carbonate raw material, and the like, so that each composition shown in Table 4 was attained. The raw material powder was fed into a quartz crucible and was melted in a nitrogen atmosphere at 950° C. for 40 minutes by using an electric furnace, causing vitrification thereof.

Next, the molten glass was poured between a pair of rotating rollers and was formed, while being quenched, into a film-shaped glass having a thickness of 0.1 to 2 mm. The film-shaped glass was fed into a ball mill using zirconia balls with diameters of 2 to 3 cm and was pulverized at 100 rpm for 3 hours, and the pulverized glass was then passed through a resin sieve having a mesh size of 120 μm, obtaining glass coarse powder having an average particle diameter D₅₀ of 8 to 15 μm. Next, the glass coarse powder was fed into a ball mill using zirconia balls each with a diameter of 5 mm, ethanol was added thereto, and the glass coarse powder was pulverized at 40 rpm for 5 hours, followed by drying at 200° C. for 4 fours, obtaining glass powder having an average particle diameter of 2 to 5 μm (a negative electrode active material for a non-aqueous secondary battery). Note that a pure substance sample was used as a negative electrode active material without any treatment for each of Comparative Examples 2 and 3.

(2) Powder X-Ray Diffraction (Powder XRD) Measurement

Each sample was subjected to powder X-ray diffraction measurement to identify its crystal structure. Each sample was measured by using RINT 2000 manufactured by Rigaku Corporation as a powder X-ray diffraction measurement apparatus and using CuKα-rays as a X-ray source under the following conditions, thereby yielding a diffraction line profile.

Tube voltage/tube current: 40 kV/40 mA

Divergence/scattering slit: 1°
Receiving slit: 0.15 mm
Sampling width: 0.01°
Measurement range: 10 to 60°
Measurement rate: 0.1°/sec
Cumulative number: 5

Table 4 shows the precipitated crystal phase and crystallinity of each negative electrode active material. The negative electrode active materials of Examples 1 to 4 and 6 were amorphous and no crystal was detected. Example 5 was almost amorphous, but a crystal was partially detected. In the negative electrode active material of Comparative Example 1, a SnO raw material was oxidized, and a SnO₂ crystal and a SnO crystal were detected. A SnO crystal and a metal Sn crystal were detected in Comparative Example 2 and Comparative Example 3, respectively, at a ratio of 100%.

TABLE 4

| | | Example | | | | | | Comparative Example | | |
|---|---|---|---|---|---|---|---|---|---|---|
| | | 1 | 2 | 3 | 4 | 5 | 6 | 1 | 2 | 3 |
| Composition of | SnO | 68 | 71 | 76 | 81 | 86 | 63 | 97 | 100 | |
| negative electrode | P₂O₅ | 32 | 29 | 24 | 19 | 14 | 20 | 3 | | |
| active material | Al₂O₃ | | | | | | 3 | | | |
| [mol %] | B₂O₃ | | | | | | 11 | | | |
| | MgO | | | | | | 3 | | | |
| | Metal Sn | | | | | | | | | 100 |
| | SnO/P₂O₅ | 2.1 | 2.4 | 3.2 | 4.3 | 6.1 | 3.2 | 32.3 | — | — |
| Precipitated crystal | | Absent | Absent | Absent | Absent | SnO₂ | Absent | SnO₂ SnO | SnO | Sn |
| Crystallinity [%] | | 0 | 0 | 0 | 0 | 4 | 0 | ≈100 | 100 | 100 |
| Charge-discharge | Initial charge | 1146 | 1126 | 1141 | 1179 | 1197 | 1133 | 1323 | 1325 | 1000 |
| performance | capacity [mAh/g] | | | | | | | | | |
| | Initial discharge | 550 | 562 | 567 | 642 | 708 | 555 | 686 | 694 | 900 |
| | capacity [mAh/g] | | | | | | | | | |
| | Initial charge-dis- | 47.9 | 49.9 | 49.7 | 54.5 | 59.1 | 49.0 | 51.8 | 52.4 | 90.0 |
| | charge efficiency [%] | | | | | | | | | |
| | Discharge capacity | 488 | 497 | 464 | 411 | 406 | 502 | 144 | 139 | 90 |
| | at 50th cycle [mAh/g] | | | | | | | | | |

(3) Preparation of Negative Electrode

Each glass powder (negative electrode active material) obtained above, a polyimide resin as a binder, and ketjen black as a conductive material were weighed so as to satisfy a ratio of glass powder:binder:conductive material=85:10:5 (weight ratio), and were dispersed in N-methylpyrrolidone (NMP), followed by sufficient stirring with a rotation-revolution mixer, obtaining a slurry-like negative electrode material. Next, a doctor blade with an gap of 150 μm was used to coat a copper foil having a thickness of 20 μm and serving a negative electrode current collector with the resultant negative electrode material, and the coated copper foil was dried at 70° C. with a dryer and was then passed through and pressed between a pair of rotating rollers, obtaining an electrode sheet. An electrode punching machine was used to punch a piece having a diameter of 11 mm out of the electrode sheet, and the piece was dried at 200° C. for 10 hours under reduced pressure so that the polyimide resin was imidized, yielding a circular working electrode (negative electrode).

(4) Preparation of Test Battery

The working electrode was placed with its copper foil surface facing downward on a lower lid of a coin cell, and there were laminated, on the working electrode, a separator formed of a polypropylene porous film (Celgard #2400 manufactured by Hoechst Celanese Corporation) having a diameter of 16 mm, which had been dried under reduced pressure at 60° C. for 8 hours, and metal lithium serving as an opposite electrode, thus producing a test battery. Used as an electrolytic solution was a 1 M LiPF₆ solution/EC:DEC=1:1 (EC=ethylene carbonate, DEC=diethyl carbonate). Note that the assembly of the test battery was carried out in an environment of a dew-point temperature of −60° C. or less.

(5) Evaluation Test of Charge-Discharge Performance

Table 4 shows the results which were obtained when the coin cell was charged and discharged. Evaluation conditions are as follows. Charge (storage of Li ions in a negative electrode active material) was carried out by 0.2 mA constant current (CC) charge to 0 V. Next, discharge (release of Li ions from the negative electrode active material) was carried out by discharge at a constant current of 0.2 mA to 1 V. The charge and discharge were repeated to evaluate the cycle performance of the negative electrode.

(6) XRD Measurement of Negative Electrode Active Material Carried Out when Charge and Discharge were Completed

A negative electrode was taken out from a coin cell when charge was completed to 0 V, and a negative electrode was taken out from a coin cell when discharge was completed to 1 V. The negative electrodes were immersed and washed in dimethyl carbonate (DMC). After that, the negative electrodes were dried under reduced pressure at room temperature overnight. Each negative electrode was measured by using M06XCE manufactured by Bruker AXS, Inc. as a X-ray diffraction measurement apparatus and using Cu Kα-rays as a X-ray source under the following conditions, thereby obtaining a diffraction line profile of the negative electrode active material in the each negative electrode.

Tube voltage/tube current: 40 kV/100 mA

Divergence/scattering slit: 1°
Receiving slit: 0.15 mm
Sampling width: 0.02°
Measurement range: 5 to 70°

(7) Analysis and Data Analysis

JADE Ver. 6.0 manufactured by Materials Data, Inc. was used as analysis software to carry out the data analysis of the diffraction line profile. First, a background diffraction line profile was subtracted from a diffraction line profile in the range of 5 to 70°, obtaining diffraction line profiles of negative electrode active materials (FIGS. 4 and 5). In these diffraction line profiles, the apex and full width at half maximum (FWHM) of each diffraction line peak were determined.

Table 5 shows the results of the apex and the full width at half maximum determined from each of the diffraction line profiles of the negative electrode active materials of the examples after completion of charge and completion of discharge, and Table 6 shows those of the comparative examples. Further, the composition of each negative electrode active material after completion of discharge is shown in terms of mol %. Here, the value of each Sn component shown is a value calculated in terms of SnO.

TABLE 5

| | | | Example | | | | | | | |
|---|---|---|---|---|---|---|---|---|---|---|
| | | | 1 | 2 | 3 | 4 | 5 | | 6 | |
| XRD | After | Apex (°) | 23 | 23 | 23 | 23.3 | 23.5 | | 23 | |
| results | completion | Full width at half | 5.2 | 4.3 | 3.5 | 2.6 | 1.6 | | 5.6 | |
| | of charge | maximum (°) | | | | | | | | |
| | | Apex (°) | 38.4 | 38.4 | 38.5 | 38.7 | 38.7 | | 38.7 | |
| | | Full width at half | 6.3 | 5.4 | 4.3 | 3.7 | 2.5 | | 6.6 | |
| | | maximum (°) | | | | | | | | |
| | After | Apex (°) | 31 | 31 | 31 | 31 | 30.7 | 32 | 30.7 | 32 |
| | completion | Full width at half | 7.3 | 6.8 | 5.1 | 3.6 | 1.9 | 2.3 | 0.8 | 1.1 |
| | of discharge | maximum (°) | | | | | | | | |

| | | | | | | | |
|---|---|---|---|---|---|---|---|
| Composition after | SnO | 30 | 33 | 35 | 40 | 46 | 39 |
| completion of | P₂O₅ | 14 | 13 | 11 | 9 | 8 | 12 |
| discharge [mol %] | Al₂O₃ | | | | | | 2 |
| | B₂O₃ | | | | | | 7 |
| | MgO | | | | | | 2 |
| | Li₂O | 56 | 54 | 54 | 51 | 46 | 38 |
| | SnO/P₂O₅ | 2.1 | 2.4 | 3.2 | 4.3 | 6.1 | 3.2 |

TABLE 6

| | | | Comparative Example | | | | | |
|---|---|---|---|---|---|---|---|---|
| | | | 1 | | 2 | | 3 | |
| XRD | After | Apex (°) | 22.4 | | 22 | | 22 | |
| results | completion | Full width at half | 0.4 | | 0.4 | | 0.3 | |
| | of charge | maximum (°) | | | | | | |
| | | Apex (°) | 38 | | 38 | | 38 | |
| | | Full width at half | 0.4 | | 0.3 | | 0.4 | |
| | | maximum (°) | | | | | | |
| | After | Apex (°) | 30.7 | 32 | 30.6 | 32 | 30.6 | 32 |
| | completion | Full width at half | 0.08 | 0.09 | 0.08 | 0.09 | 0.05 | 0.07 |
| | of discharge | maximum (°) | | | | | | |

| | | | | |
|---|---|---|---|---|
| Composition after | SnO | 47.4 | 50 | 100 |
| completion of | P₂O₅ | 1.5 | | |
| discharge [mol %] | Al₂O₃ | | | |
| | B₂O₃ | | | |
| | MgO | | | |
| | Li₂O | 51.1 | 50 | |
| | SnO/P₂O₅ | 32.3 | — | — |

The discharge capacity of the battery using the negative electrode active material of each of Examples 1 to 6 at the 50th cycle was as good as 406 mAh/g or more. On the other hand, the discharge capacity of the battery using the negative electrode active material of each of Comparative Examples 1 to 3 at the 50th cycle was as remarkably low as 144 mAh/g or less.

### Example 4

Hereinafter, the negative electrode active material for an electricity storage device according to Embodiment 4 is described in detail by way of examples, but the present invention is not limited to these examples.

(1) Preparation of Negative Electrode Active Material for Non-Aqueous Secondary Battery

Tables 7 and 8 show Examples 1 to 14 and Comparative Examples 1 and 2. Each negative electrode active material was prepared as follows.

Raw material powder was prepared by using a complex oxide of tin and phosphorus (stannous pyrophosphate:Sn₂P2O₇) as the main raw material together with various oxides, a carbonate raw material, a metal, a carbon raw material, and the like, so that each composition shown in Tables 7 and 8 was attained. The raw material powder was fed into an alumina crucible and was melted in a nitrogen atmosphere at 950° C. for 40 minutes by using an electric furnace, causing vitrification thereof.

Next, the molten glass was poured between a pair of rotating rollers and was formed, while being quenched, into a film-shaped glass having a thickness of 0.1 to 2 mm with the rotating rollers. In regard to each of Examples 1 to 14 and Comparative Example 1, the film-like glass was pulverized with an alumina stirring grinder, and the pulverized glass was then passed through a sieve having a mesh size of 20 μm, obtaining glass powder having an average particle diameter of 5 μm (a negative electrode material for a non-aqueous secondary battery). In regard to Example 15, the film-like glass was subjected to alcohol wet milling by using a bead mill. In regard to Example 16, the film-like glass was subjected to alcohol wet milling by using a ball mill. In regard to Example 17, the film-like glass was subjected to dry milling by using a ball mill and the milled glass was passed through a sieve having a mesh size of 75 μm. Note that in Comparative Example 2, metal Sn powder (manufactured by KANTO CHEMICAL CO., INC.) was used as a negative electrode active material for a non-aqueous secondary battery without any further treatment.

Each sample was subjected to powder X-ray diffraction measurement to identify its structure. The negative electrode active materials of Examples 3 to 7, 9 to 13, and 15 to 17 were amorphous and no crystal was detected. Examples 1, 2, 8, and 14 were almost amorphous, but crystals were partially detected.

(2) Preparation of Sample for Measurement of X-Ray Photoelectron Spectroscopy Spectrum

A film-like glass formed in (1) was cut into a piece with a size of 1 cm square and the piece was subjected to surface polishing, followed by washing with acetone. There was used, as a measurement sample for obtaining the binding energy value Pm of an electron on Sn 3d_{5/2} of metal Sn, a sample produced by pressing metal tin (granulated, having a purity of 99.9%) manufactured by KANTO CHEMICAL CO., INC., thereby processing into a metal plate, polishing its surface, and cleaning it with acetone.

Next, gold was attached to a part of the surface of the sample as an internal standard substance for a X-ray photoelectron spectroscopy spectrum. Specifically, masking was partially applied on the surface of the sample, and an ion sputtering apparatus (Quick auto coater JFC-1500 manufactured by JEOL Ltd.) was used to perform vacuum deposition of gold on the masked sample, thereby forming a film with a thickness of 30 nm. The resultant product was used as a sample for evaluation.

A powdered sample was dispersed in a silicon resin, followed by curing, and then gold was vapor-deposited on the surface thereof in the same manner as that for the film-like sample, thus producing a sample for evaluation.

(3) Measurement of X-Ray Photoelectron Spectroscopy Spectrum (XPS)

In the present invention, Perkin Elmer Phi MODEL 5400 ESCA was used as a X-ray photoelectron spectrometer and MgK-rays (1253.6 eV) were used as a X-ray source. The sample for evaluation fixed on a sample holder with a conductive carbon tape was introduced into the XPS apparatus and was left to stand still under reduced pressure for 1 hour in a pre-chamber in the apparatus. Next, the sample for evaluation was placed in an ultra vacuum (10-8 Pa level) measuring chamber. The measurement position was adjusted so that information on the gold deposited on the surface of the sample and information on the measurement sample were provided at the same time. Note that, if the heights (Z axis direction) of samples for evaluation are different from each other, the focal position of X-rays varies on the surfaces of the samples, influencing the detection intensities of photoelectrons, and hence the samples for evaluation were placed at the same height level.

Besides, the surface of each sample was cleaned by etching with Ar ions.

<Etching Conditions>

Ion current: 3 μA
Raster size: 50%×50% (50 mm×50 mm)
Accelerating voltage: 3 kV
Emission current in an ion gun: 25 mA
Etching time: 2 minutes

### <Measurement Conditions>

In the spectrum region of each element:
Repeat number: 3
Cycle number: 5
X-ray output: 15 kV 400 W
Pass energy: 44.75 eV
Measurement step: 0.1 eV
Each step time: 50 ms
Analysis area: 0.6 mmφ
Detection angle: 45°

(4) Analysis and Data Analysis

PHI MaltiPak Ver. 6.0 was used as analysis software to carry out the data analysis of the XPS spectrum. First, charge correction was carried out to convert the Au 4f_{7/2} orbital of gold attached as an internal standard substance to the value of 83.8 eV. Next, the binding energy value Pl of a Sn atom at 3d_{5/2} in a negative electrode active material and the binding energy value Pm of a Sn atom at 3d_{5/2} in metal Sn were calculated. The Pl, Pm, and binding energy difference (Pl−Pm) of each sample are shown in Tables 7 to 9 show.

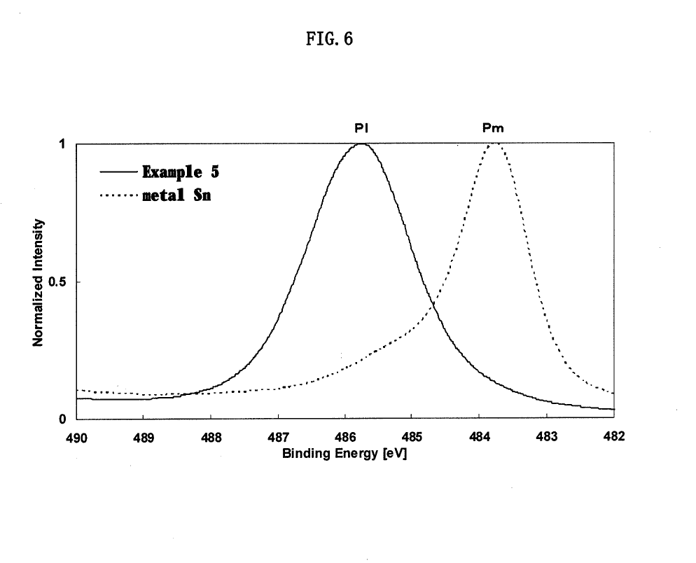

Note that FIG. 6 shows a XPS spectrum of the 3d_{5/2} orbital of a Sn atom in the negative electrode active material of Example 5 and a XPS spectrum of the 3d_{5/2} orbital of metal Sn. The binding energy values of the points at which the maximum intensity was detected in each of the XPS spectra were described as Pl and Pm, respectively, in the figure.

(5) Measurement of Properties of Powder

A laser diffraction particle size analyzer SALD-2000J manufactured by Shimadzu Corporation was used to measure an average particle diameter D50 and a maximum particle diameter D100.

A powder tester PT-S manufactured by Hosokawa Micron Corporation was used to measure a tap density under the conditions described previously.

FlowSorb II 2200 manufactured by Micromeritics Instrument Corporation was used to measure a BET specific surface area.

(6) Preparation of Negative Electrode

Each glass powder (negative electrode active material) obtained above, polyvinylidene fluoride (PVDF) as a binder, and ketjen black as a conductive material were weighed so as to satisfy a ratio of glass powder:binder:conductive material=85:10:5 (weight ratio), and were dispersed in N-methylpyrrolidone (NMP), followed by sufficient stirring with a rotation-revolution mixer, obtaining a slurry-like negative electrode material. Next, a doctor blade with an gap of 150 μm was used to coat a copper foil having a thickness of 20 μm and serving as a negative electrode current collector with the resultant slurry, and the coated copper foil was dried with a dryer at 70° C. and was then passed through and pressed between a pair of rotating rollers, obtaining an electrode sheet. An electrode punching machine was used to punch a piece having a diameter of 11 mm out of the electrode sheet, and the piece was dried at 120° C. for 3 hours under reduced pressure, obtaining a circular working electrode.

(7) Preparation of Test Battery

The working electrode was placed with its copper foil surface facing downward on a lower lid of a coin cell, and there were laminated, on the working electrode, a separator formed of a polypropylene porous film (Celgard #2400 manufactured by Hoechst Celanese Corporation) having a diameter of 16 mm, which had been dried under reduced pressure at 60° C. for 8 hours, and metal lithium serving as an opposite electrode, thus preparing a test battery. Used as an electrolytic solution was a 1 M LiPF₆ solution/ethylene carbonate (EC):diethyl carbonate (DEC)=1:1. Note that the assembly of the test battery was carried out in an environment of a dew-point temperature of −60° C. or less.

(8) Charge-Discharge Test

Charge (storage of lithium ions in a negative electrode material) was carried out by 0.2 mA constant current (CC) charge from 2 V to 0 V. Next, discharge (release of lithium ions from the negative electrode active material) was carried out by discharge at a constant current of 0.2 mA from 0 V to 2 V. This charge-discharge cycle was repeated.

Table 7 to Table 9 show the results of initial charge-discharge performance and the results of cycle performance when repeated charge and discharge was carried out in the charge-discharge test for the batteries using the negative electrode active materials of the examples and comparative examples.

TABLE 7

| | | Example | | | | | | | |
|---|---|---|---|---|---|---|---|---|---|
| | | 1 | 2 | 3 | 4 | 5 | 6 | 7 | 8 |
| Composition | SnO | 57 | 62 | 67 | 72 | 77 | 82 | 61 | 45 |
| [mol %] | (Metal Sn*) | (1.2) | (0.9) | (0.9) | (0.8) | (0.5) | (0.5) | (0.5) | (0.5) |
| | P₂O₅ | 43 | 38 | 33 | 28 | 23 | 18 | 30 | 22 |
| | Li₂O | | | | | | | 9 | 33 |
| | Al₂O₃ | | | | | | | | |
| | B₂O₃ | | | | | | | | |
| | SnO/P₂O₅ | 1.3 | 1.6 | 2.0 | 2.6 | 3.3 | 4.6 | 2.0 | 2.0 |
| Precipitated crystal | | SnP₂O₇ | SnP₂O₇ | — | — | — | — | — | Li₃PO₄ Sn |
| Results of XPS | Pl | 486.7 | 486.6 | 486.3 | 486.0 | 485.7 | 485.6 | 486.4 | 486.2 |
| characteristic | Pm | 483.7 | 483.7 | 483.7 | 483.7 | 483.7 | 483.7 | 483.7 | 483.7 |
| Sn 3d_{5/2} [eV] | Pl − Pm | 3.0 | 2.9 | 2.6 | 2.3 | 2.0 | 1.9 | 2.7 | 2.5 |
| Initial charge- | Charge capacity | 994 | 1044 | 1016 | 1020 | 1029 | 1069 | 858 | 615 |
| discharge | [mAh/g] | | | | | | | | |
| performance | Discharge capacity | 519 | 567 | 555 | 585 | 612 | 672 | 534 | 394 |
| | [mAh/g] | | | | | | | | |
| | Efficiency | 52 | 54 | 55 | 57 | 59 | 63 | 62 | 64 |
| | [%] | | | | | | | | |

| | | | | | | | | |
|---|---|---|---|---|---|---|---|---|
| Cycle performance (discharge | 369 | 371 | 343 | 471 | 291 | 267 | 342 | 253 |
| capacity at 20th cycle) [mAh/g] | | | | | | | | |

*The content of SnO added as metal Sn of all SnO in the composition is shown.

TABLE 8

| | | | | | | | | Comparative | |
|---|---|---|---|---|---|---|---|---|---|
| | | Example | | | | | | Example | |
| | | 9 | 10 | 11 | 12 | 13 | 14 | 1 | 2 |
| Composition | SnO | 62 | 62 | 62 | 62 | 62 | 62 | 40 | |
| [mol %] | P₂O₅ | 21 | 21 | 21 | 21 | 21 | 21 | 60 | |
| | Li₂O | | | | | | | | |
| | Al₂O₃ | 3.0 | 3.0 | 3.0 | 3 | 3 | 3 | | |
| | (Metal Al*) | (0.2) | (0.4) | (0.6) | | | | | |
| | B₂O₃ | 11 | 11 | 11 | 11 | 11 | 11 | | |
| | MgO | 3 | 3 | 3 | 3 | 3 | 3 | | |
| | Metal Sn | | | | | | | | 100 |
| | SnO/P₂O₅ | 3.0 | 3.0 | 3.0 | 3.0 | 3.0 | 3.0 | 0.7 | — |
| Addition amount of carbon [mass %] | | | | | 0.1 | 0.05 | | | |
| Precipitated crystal | | — | — | — | — | — | SnO₂ | SnP₂O₇ | Sn |
| Results of XPS | Pl | 485.7 | 485.6 | 485.4 | 486.3 | 486.6 | 486.6 | 487.1 | 483.5 |
| characteristic | Pm | 483.8 | 483.8 | 483.8 | 483.8 | 483.8 | 483.4 | 483.5 | 483.5 |
| Sn3d_{5/2} [eV] | Pl − Pm | 1.9 | 1.8 | 1.6 | 2.5 | 2.8 | 3.2 | 3.6 | 0.0 |
| Initial charge- | Charge capacity | 1060 | 1046 | 1030 | 1081 | 1076 | 1066 | 687 | 724 |
| discharge | [mAh/g] | | | | | | | | |
| performance | Discharge capacity | 623 | 636 | 647 | 603 | 596 | 583 | 325 | 434 |
| | [mAh/g] | | | | | | | | |
| | Efficiency | 59 | 61 | 63 | 56 | 55 | 55 | 47 | 60 |
| | [%] | | | | | | | | |

| | | | | | | | | |
|---|---|---|---|---|---|---|---|---|
| Cycle performance (discharge | Not | Not | 328 | Not | Not | Not | Not | 15 |
| capacity at 20th cycle) [mAh/g] | measured | measured | | measured | measured | measured | measured | |

*The content of Al₂O₃ added as metal Al of all Al₂O₃ in the composition is shown.

TABLE 9

| | | Example | | |
|---|---|---|---|---|
| | | 15 | 16 | 17 |
| Composition | SnO | 72 | 72 | 72 |
| [mol %] | (Metal Sn*) | (0.1) | (0.1) | (0.1) |
| | P₂O₅ | 28 | 28 | 28 |
| | Li₂O | | | |
| | Al₂O₃ | | | |
| | B₂O₃ | | | |
| | SnO/P₂O₅ | 2.6 | 2.6 | 2.6 |
| Precipitated crystal | | — | — | — |
| Properties of | Average particle | 0.3 | 3.4 | 10.8 |
| powder | diameter [μm] | | | |
| | Maximum particle | 5.4 | 30.9 | 76.6 |
| | diameter [μm] | | | |
| | Tap density [g/cm³] | 0.32 | 1.72 | 2.58 |
| | Specific surface area | 21.5 | 1.54 | 0.09 |
| | [m²/g] | | | |
| Results of XPS | Pl | 486.1 | 486.1 | 486.1 |
| characteristic | Pm | 483.7 | 483.7 | 483.7 |
| Sn3d_{5/2} [eV] | Pl − Pm | 2.4 | 2.4 | 2.4 |
| Initial | Charge capacity | 1015 | 1015 | 1020 |
| charge-discharge | [mAh/g] | | | |
| performance | Discharge capacity | 543 | 595 | 585 |
| | [mAh/g] | | | |
| | Efficiency [%] | 54 | 59 | 57 |

| | | | |
|---|---|---|---|
| Cycle performance (discharge capacity | 447 | 490 | 407 |
| at 20th cycle) [mAh/g] | | | |

*The content of SnO added as metal Sn of all SnO in the composition is shown.

In each of Examples 1 to 14, the binding energy difference (Pl−Pm) based on XPS was in the range of 1.6 to 3.2 eV and the initial charge-discharge efficiency was as excellent as 52% or more. On the other hand, in Comparative Example 1, the binding energy difference (Pl−Pm) based on XPS was as large as 3.6 eV, and hence the initial charge-discharge efficiency was as low as 47%. Further, in each of Examples 1 to 14, even after 20 cycles of repeated charge and discharge were performed, the discharge capacity was 253 mAh/g or more. On the other hand, in Comparative Example 2, the binding energy difference (Pl−Pm) based on XPS was as small as 0 eV, and hence the initial charge-discharge efficiency was 60%, but after 20 cycles of repeated charge and discharge were performed, the discharge capacity was as low as 15 mAh/g.

In each of Examples 15 to 17, the binding energy difference (Pl−Pm) based on XPS was 2.4 eV, the initial charge-discharge efficiency was 54% or more, and after 20 cycles of repeated charge and discharge were performed, the discharge capacity was as excellent as 407 mAh/g or more. In particular, Example 16 was excellent in initial charge-discharge efficiency and cycle performance, because it had predetermined properties of powder and a homogeneous electrode was able to be produced.

### INDUSTRIAL APPLICABILITY

The negative electrode active material for an electricity storage device of the present invention is suitable for a lithium ion non-aqueous secondary battery used for portable electronic devices such as notebook computers and portable phones, electric vehicles, and the like, and a hybrid capacitor such as a lithium ion capacitor, and the like.

1-24. (canceled)

25. A negative electrode active material for an electricity storage device, comprising at least SnO and P₂O₅, the negative electrode active material having an amorphous halo in a range of 10 to 450 in terms of a 2θ value in a diffraction line profile obtained by powder X-ray diffraction measurement using Cu Kα-rays,
wherein, when a curve fitting of the amorphous halo is performed in the range of 10 to 45° in terms of the 20 by two components, that is, a peak component P1 at the 2θ value which is fixed to 22.5° and a peak component P2 at the 2θ value on a higher angle side than 22.5°, a position of an apex of the peak component P2 is in a range of 25.0 to 29.0° in term of the 2θ value.

26. The negative electrode active material for an electricity storage device according to claim 25, comprising, as a composition expressed in terms of mol %, 45 to 95% of SnO and 5 to 55% of P₂O₅.

27. The negative electrode active material for an electricity storage device according to claim 25, which is substantially amorphous.

28. A negative electrode material for an electricity storage device, comprising the negative electrode active material for an electricity storage device according to claim 25.
